(19) United States
(12) Patent Application Publication
(10) Pub. No.: US 2012/0084650 A1
(43) Pub. Date: Apr. 5, 2012

(54) INFORMATION PROCESSING DEVICE AND INFORMATION PROCESSING METHOD

(75) Inventor: Kouichi UCHIMURA, Kanagawa (JP)

(73) Assignee: Sony Corporation, Tokyo (JP)

(21) Appl. No.: 13/235,846

(22) Filed: Sep. 19, 2011

(30) Foreign Application Priority Data
Oct. 1, 2010 (JP) 2010-223705

(51) Int. Cl. G06F 3/048

(52) U.S. Cl. 715/716

(57) ABSTRACT

An information processing device includes an information processing unit that determines whether or not a button indicated by an operation is a button which is not expected to be directly indicated, based on button related information which is formed by correlating information related to each button displayed on a screen with each button and is recorded on a necessary recording medium, and operation input information from an operation unit where an operation for directly indicating a display region of each button can be performed, in relation to the button displayed in a predetermined display region on the screen based on the button related information recorded on the recording medium, and does not execute a command correlated with the button related information of the indicated button if the indicated button is the button which is not expected to be directly indicated as a result of the determination.

### BACKGROUND

The present disclosure relates to an information processing device and an information processing method for processing information reproduced from a recording medium.

As an optical recording medium which reads information through light irradiation, a BD (Blu-ray Disc: registered trademark) has come into wide use.

Among the BDs, in reproduction only, a so-called ROM type (BD-ROM), when a content item such as a movie is recorded on a disc, which is sold as a package medium, a user interface for controlling execution of various programs accompanied by the content item is recorded on the disc. There is a menu image as a representative user interface. For example, in the menu image, buttons for selecting functions are prepared as button images, and a function allocated to a corresponding button is executed by selecting and determining the button using predetermined input means.

A button generally has three states, a selection state where the button is selected, an execution state where a predetermined function correlated with a command is instructed to be executed, and a normal state which is neither the selection state nor the execution state. For example, a button displayed on a screen is made to enter a selection state by using direction indication keys (direction keys) such as cross keys provided on a remote controller belonging to a player, and the button state is transitioned, for example, from a selection state to an execution state by operating a determination key. Thereby, a command correlated with the corresponding button is executed, and a predetermined function is realized by the corresponding command.

The functions of the buttons can realize, for example, various functions such as the operation of a scene selection menu, the selection of captions, ON and OFF of the caption, and change of the spoken language without stopping reproducing moving image data.

Japanese Unexamined Patent Application Publication No. 2004-304767 discloses a technique for realizing menu display using the button images in the BD.

In addition, a stream which stores data used to perform menu display including buttons is mainly stored in a sub-stream correlated with reproduced moving image data. A plurality of sub-streams can be correlated with a piece of moving image data.

A command correlated with a button is separated and arranged by a predetermined delimiter in the notation, and is sequentially executed in designated orders.

Here, a button can be defined so as to be automatically transitioned from the selection state to the execution state. The button defined in this way is referred to as an automatic action button. For example, when a normal state of the button defined as the automatic action button is transitioned to a selection state using a remote controller or the like, the button is automatically transitioned to an execution state at the time of being transitioned to a selection state, and a command correlated with the button is executed.

In addition, a so-called hidden button may be set in order to realize a more useful function using the function of the automatic action button.

The hidden button has the above-described three states although not displayed on a screen, and can be correlated with commands. The hidden button can be realized by, for example, setting the opacity thereof to the minimum with respect to button images for displaying buttons so as to entirely transmit background display.

For example, a certain button on a pop-up menu is correlated with a command which sets the hidden button defined as the automatic action button to enter a selection state. In this way, when the corresponding button of the pop-up menu is transitioned to an execution state, a command correlated with the hidden button can be automatically executed. Thereby, for example, it is possible to realize a function of automatically enabling the pop-up menu to enter an OFF state after a scene jump.

Further, detailed use of the hidden button is also disclosed in, for example, Japanese Unexamined Patent Application Publication No. 2008-97691.

### SUMMARY

As described above, in the BD, there may be buttons which are not intended to be directly operated by a user like the hidden button.

Here, the BD standard is designed on the premise of an operation using the remote controller. That is to say, the BD standard is designed on the premise that buttons are selected or determined through operations of the cross keys or the determination keys provided on the remote controller.

For this reason, even a function using the hidden button can be realized on the premise thereof.

Meanwhile, in recent years, a user interface using a touch panel has come into use. In a case of using an interface where an arbitrary position on a screen can be directly indicated, such as the touch panel, a user can directly operate a button which is not assumed to be directly operated such as the hidden button. In other words, thereby, there is a possibility that a command correlated with the hidden button may be executed at a timing which is not intended by a player side, and, as a result, there is concern that unexpected operation errors may occur.

An information processing device according to the present disclosure may have the following configuration.

That is to say, the information processing device includes an information processing unit that determines whether or not a button indicated by an operation is a button which is not expected to be directly indicated, based on button related information which is formed by correlating information related to each button displayed on a screen with each button and is recorded on a necessary recording medium, and operation input information from an operation unit where an operation for directly indicating a display region of each button can be performed, in relation to the button displayed in a predetermined display region on the screen based on the button related information recorded on the recording medium, and does not execute a command correlated with the button related information of the indicated button if the indicated button is the button which is not expected to be directly indicated as a result of the determination.

According to the present disclosure, for example, in a case where there is a button which is not expected to be directly operated (directly indicated) by a user such as the hidden button in the BD standard, it is possible to effectively prevent occurrence of operation errors caused by a sudden operation of the button (at an unexpected timing).

According to the present disclosure, in a case where an operation unit such as, for example, a touch panel where a display region of a button on a screen can be directly indicated is provided, it is possible to effectively prevent occurrence of operation errors caused by a direct operation of a button which is not expected to be directly operated by a user, such as, for example, the hidden button in the BD standard.

### BRIEF DESCRIPTION OF THE DRAWINGS

FIG. 1 is an outlined line diagram schematically illustrating a data model of a BD-ROM.

FIG. 2 is an outlined line diagram illustrating an index table.

FIG. 3 is a UML diagram illustrating relationships among a clip AV stream, clip information, a clip, a play item, and a play list.

FIG. 4 is an outlined line diagram illustrating a method of referring to the same clip from a plurality of play lists.

FIG. 5 is an outlined line diagram illustrating a sub-path.

FIG. 6 is an outlined line diagram illustrating a management structure of a file recorded in a recording medium.

FIGS. 7A and 7B are flowcharts schematically illustrating an operation of a BD virtual player.

FIG. 8 is an outlined line diagram schematically illustrating an operation of the BD virtual player.

FIG. 9 is an outlined line diagram illustrating an example of a plane structure used as a display system of an image according to an embodiment of the present disclosure.

FIG. 10 is a block diagram illustrating an exemplary configuration where a moving image plane, a caption plane, and a graphics plane are synthesized with each other.

FIG. 11 is an outlined line diagram illustrating an exemplary palette table stored in a palette.

FIGS. 12A to 12D are outline line diagrams illustrating an exemplary storage format of a button image.

FIG. 13 is an exemplary state transition diagram of a button displayed on the graphics plane.

FIGS. 14A to 14F are outlined line diagrams illustrating configurations of a menu screen and buttons.

FIG. 15 is an outlined line diagram illustrating a syntax illustrating an exemplary configuration of header information of ICS.

FIG. 16 is an outlined line diagram illustrating a syntax indicating an exemplary structure of a block interactive_composition_data_fragment( ).

FIG. 17 is an outlined line diagram illustrating a syntax indicating an exemplary structure of a block page( ).

FIG. 18 is an outlined line diagram illustrating a syntax indicating an exemplary structure of a block button_overlap_group( ).

FIG. 19 is an outlined line diagram illustrating a syntax indicating an exemplary structure of a block button( ).

FIG. 20 is a block diagram illustrating an exemplary decoder model of interactive graphics.

FIG. 21 is an outlined line diagram illustrating an exemplary menu image displayed by an IG stream.

FIG. 22 is an outlined line diagram illustrating a state where moving image data reproduced by a play item of a main path is displayed on a moving image plane.

FIG. 23 is an outlined line diagram illustrating exemplary display where the menu image is synthesized with moving image data which is reproduced by a play item of a main path and is displayed on a moving image plane.

FIG. 24 is an outlined line diagram illustrating an example where a pull-down menu is displayed through an operation of a determination key.

FIG. 25 is an outlined line diagram illustrating an example where a pull-down menu is displayed through an operation for designating a lower direction using cross keys or the like.

FIG. 26 is an outlined line diagram illustrating an example where a pull-down menu is displayed through an operation for designating a lower direction using cross keys or the like.

FIG. 27 is a diagram illustrating an overall internal configuration of an information processing device according to an embodiment.

FIG. 28 is a diagram illustrating a method of determining a button touch on a touch panel.

FIG. 29 is a flowchart illustrating an information processing method according to an embodiment.

### DETAILED DESCRIPTION OF EMBODIMENTS

Hereinafter, embodiments of the present disclosure will be described.

The description will be made in the following order.

1. BDMV FORMAT

1-1. OUTLINE OF FORMAT

1-2. IMAGE DISPLAY SYSTEM 1-3. IG STREAM

1-4. MODEL OF IG DECODER

1-5. SYNTHESIZED DISPLAY OF MENU IMAGE WITH VIDEO STREAM

1-6. HIDDEN BUTTON

2. CONFIGURATION OF REPRODUCTION DEVICE

3. DETERMINATION OF BUTTON TOUCH

4. INFORMATION PROCESSING METHOD ACCORDING TO EMBODIMENT

5. MODIFIED EXAMPLE

### 1. BDMV Format

### 1-1. Outline of Format

First, there will be description of a management structure of a content item, that is, AV (Audio/Video) data recorded on a BD-ROM which is a read only type BD, prescribed in “Blu-ray Disc Read-Only Format Ver 1.0 part 3 Audio Visual Specifications” in relation to a BD (Blu-ray Disc: registered trademark). Hereinafter, a management structure in the BD-ROM is referred to as a BDMV format.

For example, a bit stream which is encoded by an encoding method of an MPEG (Moving Pictures Experts Group) video or an MPEG audio and is multiplexed according to the MPEG2 system, is referred to as a clip AV stream (or an AV stream). The clip AV stream is recorded on a disc as a file depending on a file system defined by “Blu-ray Disc Read-Only Format part 2” which is one of standards for the BD. The file is referred to as a clip AV stream file (or an AV stream file).

The clip AV stream file is the management unit on a file system, and it is not typically easy for a user to understand the management unit. In consideration of the users' convenience, it is necessary to record a structure for putting image contents distributed into a plurality of clip AV stream files together into one for reproduction, a structure for reproducing a portion of clip AV stream files, information for smoothly performing special reproduction or cueing reproduction, and the like, on a disc as a database. The database is defined by “Blu-ray Disc Read-Only Format part 3” which is one of the standards for the BD.

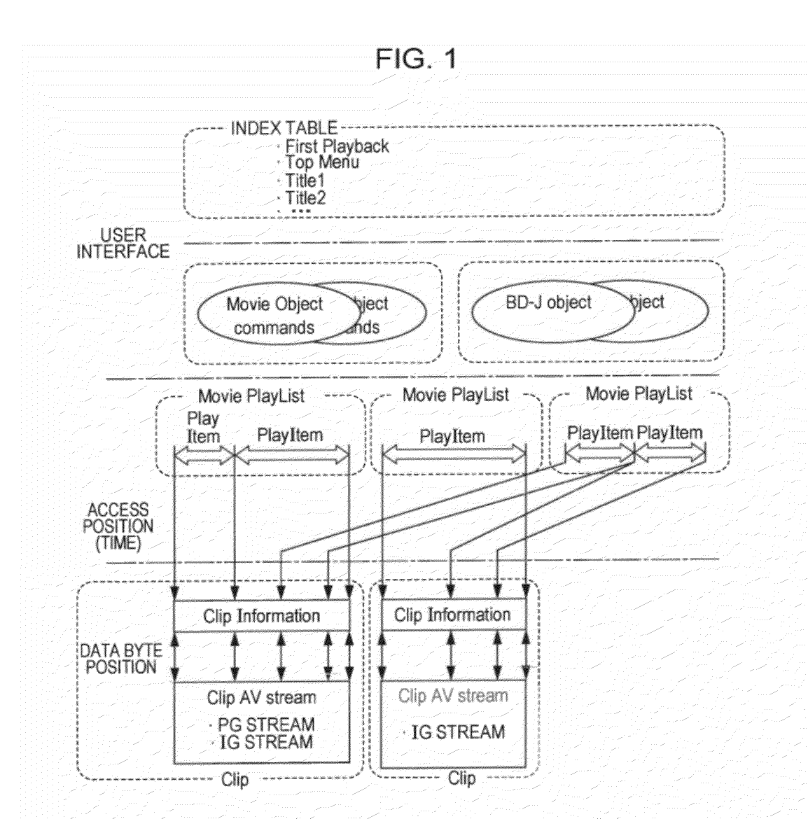

FIG. 1 schematically shows a data model of the BD-ROM. The data structure of the BD-ROM includes four layers as shown in FIG. 1. The bottom layer is a layer where a clip AV stream is disposed (for convenience, referred to as a clip layer). The layer thereon is a layer where a movie play list and a play item for designating a reproduced part of a clip AV stream are disposed (for convenience, referred to as a play list layer). The layer thereon is a layer where a movie object and the like including commands for designating a reproduced order of a movie play list are disposed (for convenience, referred to as an object layer). The top layer is a layer where an index table for managing a title and the like stored in the BD-ROM is disposed (for convenience, referred to as an index layer).

The clip layer will be described. The clip AV stream is a bit stream obtained by multiplexing video data or audio data in an MPEG2 TS (Transport Stream) format. Information regarding the clip AV stream is recorded in a file as clip information.

In addition, in the clip AV stream, a caption displayed accompanied by content data formed by video data or audio data, or a stream for displaying a menu is also multiplexed. A graphics stream for displaying a caption is referred to as a presentation graphics (PG) stream. In addition, a stream of data used to display a menu is referred to as an interactive graphics (IG) stream.

A clip AV stream file and a clip information file in which corresponding clip information is recorded are regarded as a bundle of objects, which are referred to as a clip. That is to say, the clip is one object including a clip AV stream and clip information.

A file is generally treated as a byte stream. The content of the clip AV stream file is developed on the time axis, and an entry point of the clip is mainly designated on the basis of time. If a time stamp of an access point to a predetermined clip is given, a clip information file may be used in order to find address information which is necessary to start reading data in a clip AV stream file.

The play list layer will be described. A movie play list includes a group of a reproduction start point (IN point) and a reproduction end point (OUT point) which designate an AV stream file to be reproduced and a reproduced part of the designated AV stream file. One set of information for the reproduction start point and the reproduction end point is referred to as a play item. The movie play list includes sets of play items. Reproduction of a play item is to reproduce a portion of an AV stream file referred to by the play item. In other words, a corresponding section in a clip is reproduced based on information for an IN point and an OUT point in the play item.

The object layer will be described. A movie object includes terminal information which links an HDMV navigation command program (HDMV program) to the movie object. The HDMV program is a command for controlling reproduction of a play list. The terminal information includes information for permitting an operation which is an interaction of a user with a BD-ROM player. A user operation such as invocation of a menu screen or a title search is controlled based on the terminal information.

A BD-J object includes an object formed by a Java program (where Java is a registered trademark). The BD-J object has a weak relationship with the present disclosure, and thus description thereof will be omitted.

The index layer will be omitted. The index layer includes an index table. The index table is a top level table which defines a title of the BD-ROM disc. Reproduction of the BD-ROM disc is controlled by a module manager in BD-ROM residence system software based on title information stored in the index table.

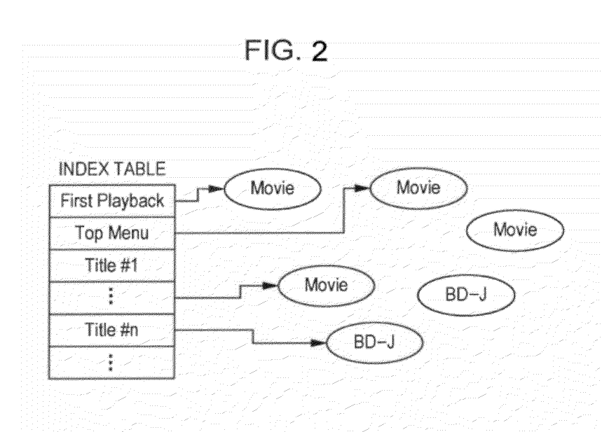

In other words, as schematically shown in FIG. 2, an arbitrary entry included in the index table is called a title, and entries included in the index table, first playback, a top menu, and titles #1, #2, . . . , are all titles. Each title indicates a link to a movie object or a BD-J object, and each title indicates either an HDMV title or a BD-J title.

For example, if a content item stored in a corresponding BD-ROM is a movie, the first playback is an image for an advertisement (trailer) of a movie company, shown prior to the main movie. For example, if a content item is a movie, the top menu is a menu screen for selecting main movie reproduction, a chapter search, setting of a caption or a language, bonus footage reproduction, and the like. In addition, the title is each image selected from the top menu. There may be a configuration where the title is another menu screen.

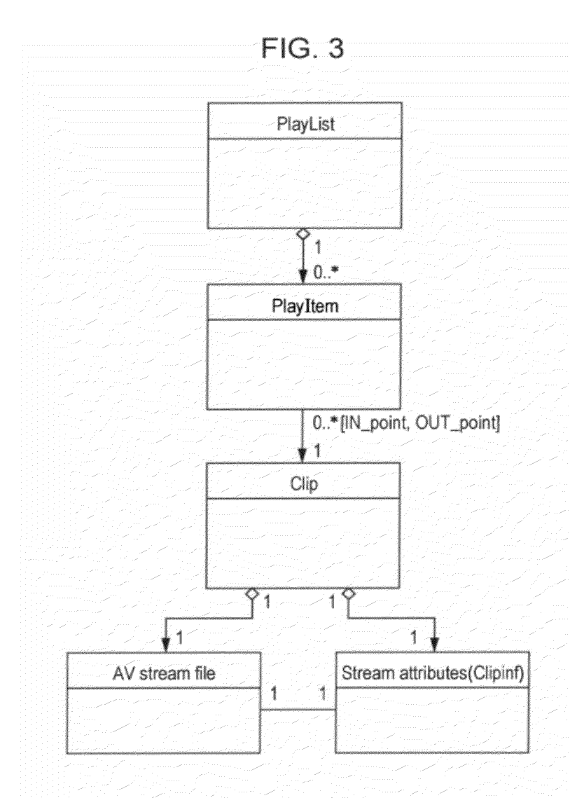

FIG. 3 is a UML (Unified Modeling Language) diagram illustrating a relationship among the above-described clip AV stream, the clip information (Stream Attributes), the clip, the play item, and the play list. The play list can be correlated with one or a plurality of play items, and the play item can be correlated with one clip. One clip can be correlated with a plurality of play items having different start points and/or end points. One clip AV stream file is referred to by one clip. In a similar manner, one clip information file is referred to by one clip. In addition, the clip AV stream file and the clip information file have a one-to-one correspondence relationship. Through the definition of the structure, it is possible to designate a non-destructive reproduction order for reproducing only an arbitrary part without changing clip AV stream files.

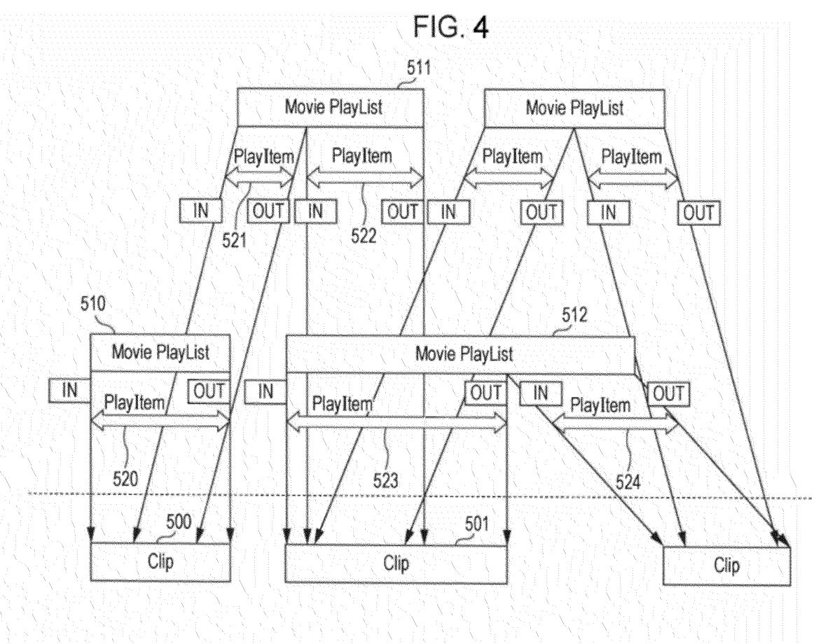

In addition, as shown in FIG. 4, the same clip may be referred to by a plurality of play lists. In addition, a plurality of clips may be designated from one play list. The clip is referred to by the IN point and the OUT point shown in a play item of a play list. In an example shown in FIG. 4, the clip 500 is referred to by the play item 520 of the play list 510, and a section thereof indicated by the IN point and the OUT point is referred to by the play item 521 of the play items 521 and 522 forming the play list 511. In addition, in the clip 501, a section thereof indicated by the IN point and the OUT point is referred to by the play item 522 of the play list 511, and a section thereof indicated by the IN point and the OUT point is referred to by the play item 523 of the play items 523 and 524 forming the play list 512.

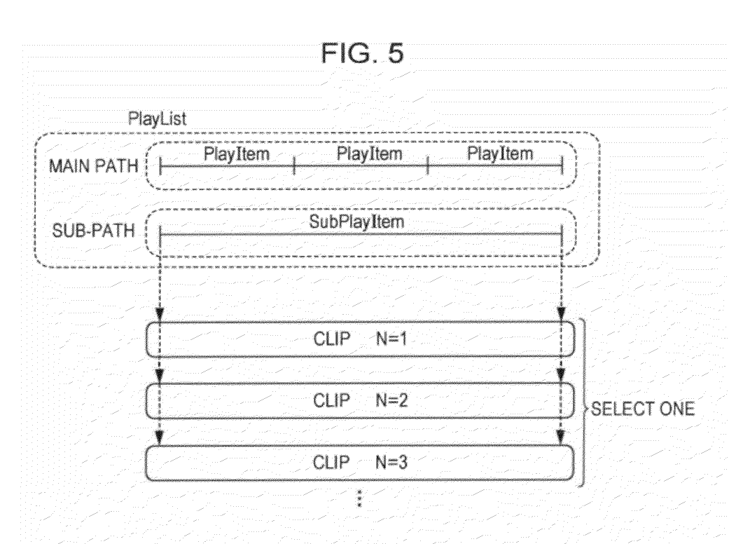

In addition, as exemplified in FIG. 5, the play list may have a main path corresponding to mainly reproduced play items, and a sub-path corresponding to a sub-play item. The sub-play item can be correlated with a plurality of other clips, and the sub-play item may selectively refer to one of the plural clips correlated with the sub-play item. Although not described in detail, the play list can have the sub-play item only in a case of satisfying a predetermined condition.

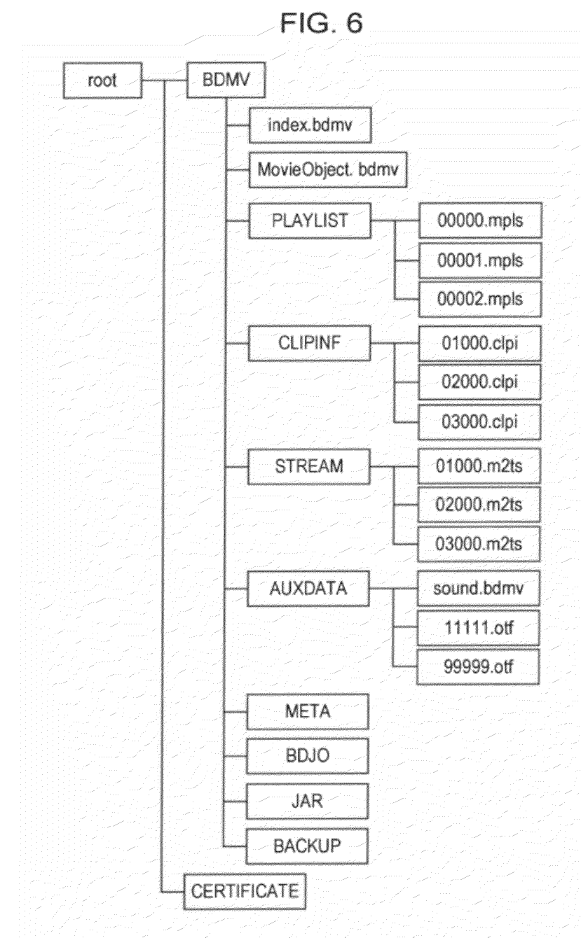

Next, the management structure of files recorded on the BD-ROM, defined in “Blu-ray Disc Read-Only Format part 3” will be described with reference to FIG. 6. The files are managed hierarchically through a directory structure. First, one directory (a root directory in the example shown in FIG. 6) is created on a recording medium. Directories under the directory are included in a range managed by one recording and reproduction system.

Under the root directory, a directory “BDMV” and a directory “CERTIFICATE” are put. Information regarding copyright is stored in the directory “CERTIFICATE”. The data structure described with reference to FIG. 1 is stored in the directory “BDMV”.

Only two files, a file “index.bdmv” and a file “MovieObject.bdmv” can be put directly under the directory “BDMV”. In addition, under the directory “BDMV”, a directory “PLAYLIST”, a directory “CLIPINF”, a directory “STREAM”, a directory “AUXDATA”, a directory “META”, a directory “BDJO”, a directory “JAR”, and a directory “BACKUP” are put.

The file “index.bdmv” describes contents of the directory BDMV. In other words, the file “index.bdmv” corresponds to the index table in the above-described index layer which is the top layer. In addition, the file “MovieObject.bdmv” stores information regarding one or more movie objects. In other words, the file “MovieObject.bdmv” corresponds to the above-described object layer.

The directory “PLAYLIST” is a directory in which a database of a play list is put. In other words, the directory “PLAYLIST” includes a file “xxxxx.mpls” which is a file regarding a movie play list. The file “xxxxx.mpls” is a file which is created for each movie play list. In the file name, “xxxxx” prior to “.” (period) is a five-digit number, and “mpls” posterior to the period is an extension fixed to this type of file.

The directory “CLIPINF” is a directory in which a database of a clip is put. In other words, the directory “CLIPINF” includes a file “zzzzz.clpi” which is a clip information file regarding each clip AV stream file. In the file name, “zzzzz” prior to “.” (period) is a five-digit number, and “clpi” posterior to the period is an extension fixed to this type of file.

The directory “STREAM” is a directory in which an AV stream file as an entity is put. In other words, the directory “STREAM” includes a clip AV stream file corresponding to each clip information file. The clip AV stream file is formed by a transport stream of MPEG2 (Moving Pictures Experts Group 2) (hereinafter, abbreviated to MPEG2 TS), and has the file name of “zzzzzz.m2ts”. In the file name, “zzzzz” prior to the period is the same as that of a corresponding clip information file, and, a correspondence relationship between the clip information file and the clip AV stream file can be easily understood.

The directory “AUXDATA” puts a sound file, a font file, a font index file, a bitmap file, and the like used to display a menu therein. Sound data related to an application of a graphics stream which is an interaction of the HDMV is stored in the file “sound.bdmv”. The file name is fixed to “sound.bdmv”. Font data used for caption display, the above-described BD-J application, or the like is stored in the file “aaaaa.otf”. In the file name, “aaaaa” prior to the period is a five-digit number, and “otf” posterior to the period is an extension fixed to this type of file. The file “bdmv.fontindex” is an index file of a font.

The directory “META” stores a metadata file. The directory “BDJO” and the directory “JAR” store files related to the above-described the BD-J object. In addition, the directory “BACKUP” stores backups of the respective directories and files described hitherto. The directory “META”, directory “BDJO”, directory “JAR” and the directory “BACKUP” have no direct relationship with the present disclosure, and thus description thereof will be omitted.

When a disc having the above-described data structure is loaded onto a player, it is necessary for the player to convert commands described in the movie object or the like which are read from the disc, into unique commands for controlling internal hardware inside the player. The player stores in advance software for performing the conversion in a ROM (Read Only Memory) embedded in the player. The software allows the player to be operated according to the standard of the BD-ROM by mediating between the disc and the player, and thus is referred to as a BD virtual player.

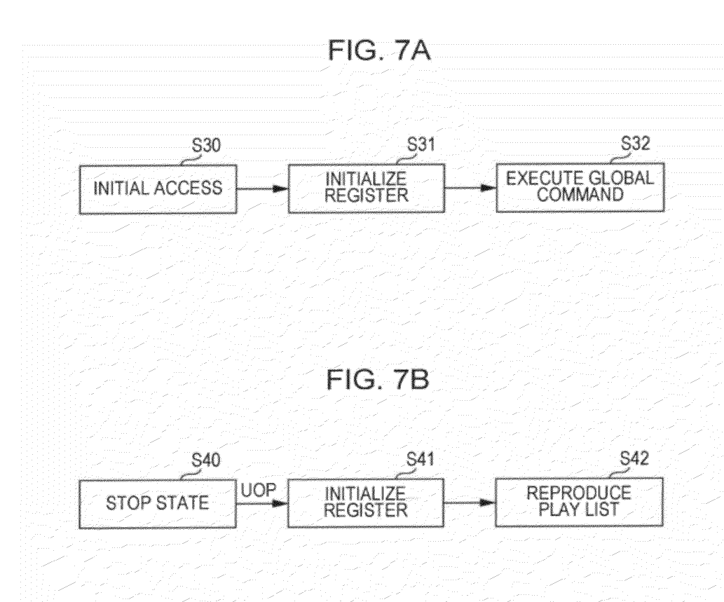

FIGS. 7A and 7B schematically show an operation of the BD virtual player. FIG. 7A shows an example of an operation at the time when a disc is loaded. When the disc is loaded onto the player, and an initial access to the disc is performed (step S30), a register storing shared parameters which are used in one disc in a shared manner is initialized (step S31). In next step S32, a program is read from the disc and is executed. In addition, the initial access indicates that the disc is first reproduced as at the time of the disc loading.

FIG. 7B shows an example of an operation when the player is instructed to reproduce through, for example, the pressing of a play key by a user in a stop state. In an initial stop state (step S40), the player is instructed to reproduce using, for example, a remote controller of the user (UO: User Operation). If the reproduction is instructed, for example, a register, that is, common parameters are initialized (step S41), and, in the next step S42, there is a transition to a reproduction phase of a play list. In addition, in this case, the register may be mounted so as not to be reset.

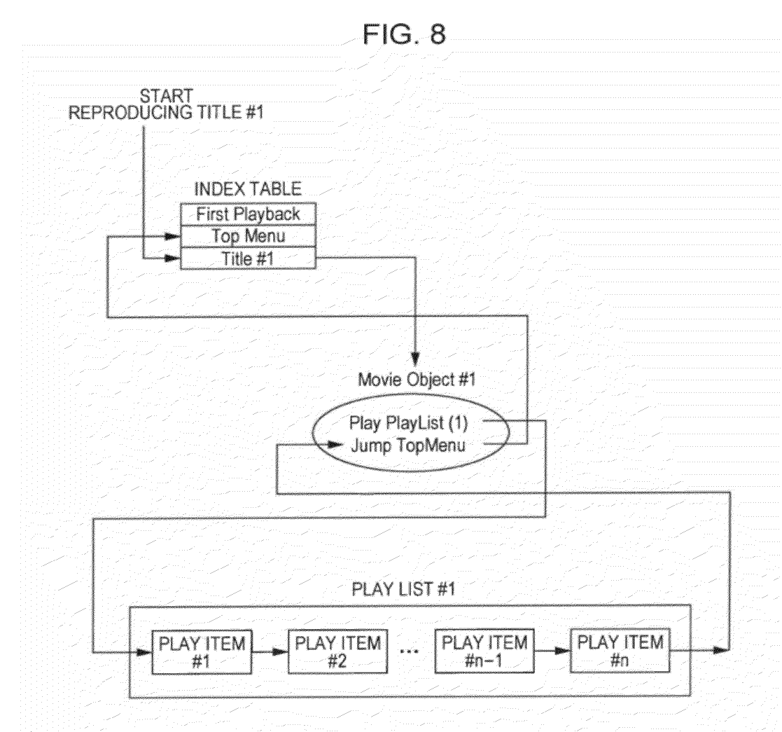

Reproduction of a play list in an execution phase of a movie object will be described with reference to FIG. 8. It is assumed that there is an instruction for starting reproducing a content item of the title #1 by a user operation. The player obtains an object number corresponding to reproduction of the content item of the title #1 by referring to the index table shown in FIG. 2 in response to the instruction for starting reproducing the content item. For example, if the object number of realizing the reproduction of the content item of the title #1 is #1, the player starts execution of the movie object #1.

In the example shown in FIG. 8, a program described in the movie object #1 is formed by two rows, and if a command in the first row is “Play PlayList(1)”, the player starts reproducing a play list #1. The play list #1 includes one or more play items, and the play items are sequentially reproduced. If reproduction of the play items in the play list #1 is completed, the player returns in order to execute the movie object #1, and a command in the second row is executed. In the example shown in FIG. 8, the command in the second row is “Jump TopMenu”, this command is executed, and execution of the movie object for realizing the top menu described in the index table is started.

### 1-2. Image Display System

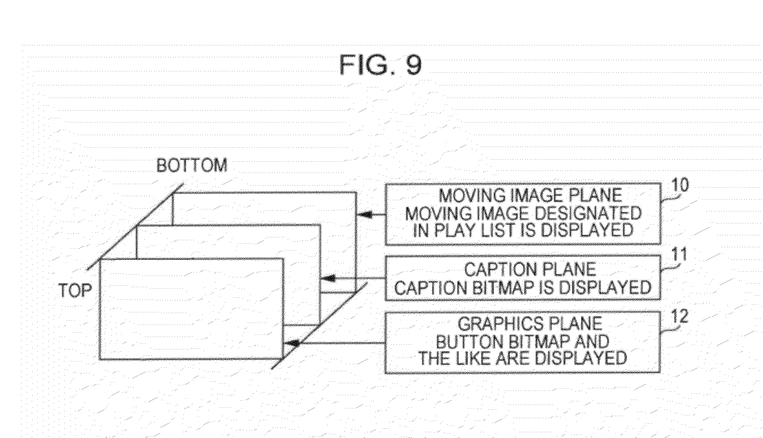

Next, an image display system applicable to the present disclosure will be described. In the embodiment, a plane configuration as exemplified in FIG. 9 is employed as the image display system.

A moving image plane 10 is displayed at the rearmost side (bottom) and treats an image (mainly moving image data) designated in a play list. A caption plane 11 is displayed on the moving image plane 10, and treats caption data displayed during reproduction of the moving images. A graphic plane 12 is displayed at the top side, and treats graphics data such as character data used to display a menu screen, bitmap data for button images, or the like. One display screen is displayed through synthesis of the three planes.

In addition, the graphics plane 12 treats data for displaying a menu screen as such, and thus the graphics plane 12 is referred to as an interactive graphics plane 12.

The moving image plane 10, the caption plane 11, and the interactive graphics plane 12 can be displayed independently from each other. The moving image plane 10 has a data length of 16 bits which is converted in terms of each pixel at the resolution of 1920 pixels×1080 lines, and is a system where a luminance signal Y, and color difference signals Cb and Cr are 4:2:2 (hereinafter, YCbCr(4:2:2)). In addition, YCbCr(4:2:2) is a color system where the luminance signal Y has 8 bits and the color difference signals Cb and Cr respectively have 8 bits for each pixel, and horizontal two pixels are regarded as forming a piece of color data. The interactive graphics plane 12 and the caption plane 11 have a sampling depth of 8 bits for each pixel at 1920 pixels×1080 lines, and the color system is an 8-bit color map address using a 256-color palette.

In the interactive graphics plane 12 and the caption plane 11, 256-step alpha blending is possible, and the opacity can be set at 256 steps when synthesized with other planes. The opacity can be set for each pixel. Hereinafter, the opacity α is in a range of (0≦α≦1), and it is assumed that the plane is completely transparent if the opacity α is 0, and the plane is completely opaque if the opacity α is 1.

In the caption plane 11, image data of, for example, a PNG (Portable Network Graphics) format is treated.

Further, in the interactive graphics plane 12 as well, image data of, for example, a PNG format can be treated.

The PNG format has 1 bit to 16 bits as a sampling depth of one pixel, and, in a case where the sampling depth is 8 bits or 16 bits, an alpha channel, that is, opacity information for pixel components (referred to as alpha data) can be added. In a case where the sampling depth is 8 bits, the opacity can be designated at 256 steps. The alpha blending is performed using the opacity information by the alpha channel. In addition, palette images of up to 256 colors, and a corresponding element (index) in a palette prepared in advance is represented by an index number.

In addition, image data treated in the caption plane 11 and the interactive graphics plane 12 is not limited to the PNG format. Image data which undergoes compression coding by other compression coding methods such as the JPEG method, image data which undergoes run-length compression, bitmap data which does not undergo compression coding, or the like may be treated.

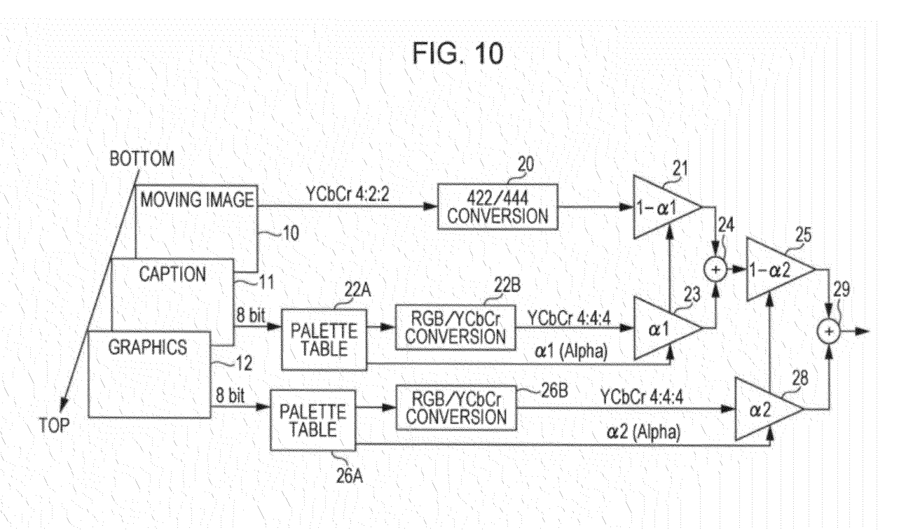

FIG. 10 shows an exemplary configuration of a graphics processing unit which synthesizes three planes with each other according to the plane configuration shown in FIG. 9. In addition, the configuration shown in FIG. 10 can be realized by both hardware and software. Moving image data of the moving image plane 10 is supplied to a 422/444 conversion circuit 20. The color system of the moving image data is converted from the YCbCr(4:2:2) into YCbCr(4:4:4) by the 422/444 conversion circuit 20, and is supplied to a multiplier 21.

Image data of the caption plane 11 is input to a palette 22A and output as image data of RGB(4:4:4). If the opacity by the alpha blending is designated to the image data, a designated opacity α1 (0≦α1≦1) is output from the palette 22A.

Palette information corresponding to a file of, for example, a PNG format is stored in the palette 22A. The palette 22A refers to an index number using the input pixel data of 8 bits as an address. Data of RGB(4:4:4) each of which is formed by 8 bits is output based on the index number. Along therewith, data a of the alpha channel indicating the opacity is extracted from the palette 22A.

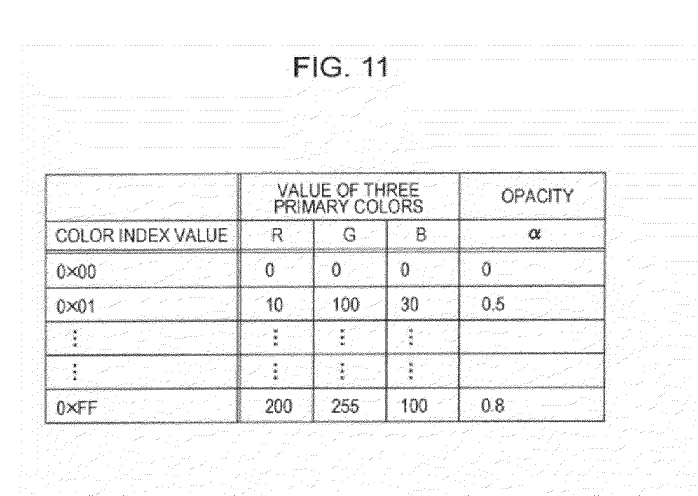

FIG. 11 shows an exemplary palette table stored in the palette 22A. Values R, G and B of three primary colors, which are expressed as 8 bits, and the opacity α are allocated to each of 256 color index values [0x00] to [0xFF] (where [0x] indicates a hexadecimal). The palette 22A refers to the palette table based on the input image data of the PNG format, and outputs color data of R, G and B (RGB data) each of which is formed by 8-bit data and the opacity α, corresponding to an index value designated by the image data, for each pixel.

The RGB data output from the palette 22A is supplied to a RGB/YCbCr conversion circuit 22B, and is converted into data of a luminance signal Y and color signals Cb and Cr each having the data length of 8 bits (hereinafter, collectively referred to as YCbCr data). Since it is necessary to perform a subsequent synthesis between the planes in a common data format, unification to the YCbCr data which is a data format of moving image data is performed.

The YCbCr data output from the RGB/YCbCr conversion circuit 22B and the opacity data α1 are input to a multiplier 23. The multiplier 23 multiplies the input YCbCr data by the opacity data α1. The multiplied result is input to one input end of an adder 24.

In addition, the multiplier 23 multiplies each of the luminance signal Y, and the color difference signals Cb and Cr in the YCbCr data by the opacity data α1. In addition, a complement number (1−α1) of the opacity data α1 is supplied to the multiplier 21.

The multiplier 21 multiplies the moving image data input from the 422/444 conversion circuit 20 by the complement number (1−α1) of the opacity data α1. The multiplied result is input to the other input end of the adder 24. The adder 24 adds the multiplied results from the multiplier 21 and the multiplier 23. Thereby, the moving image plane 10 and the caption plane 11 are synthesized with each other. The added result from the adder 24 is input to a multiplier 25.

Image data of the interactive graphics plane 12 is input to a palette 26A and is output as image data of RGB(4:4:4). If the opacity by the alpha blending is designated to the image data, a designated opacity α2 (0≦α2≦1) is output from the palette 26A. The RGB data output from the palette 26A is supplied to an RGB/YCbCr conversion circuit 26B so as to be convert-ed into YCbCr data, and is unified to the YCbCr data which is a data format of moving image data. The YCbCr data output from the RGB/YCbCr conversion circuit 26B is input to a multiplier 27.

If the image data used for the interactive graphics plane 12 has the PNG format, the opacity data α2 (0≦α2≦1) can be set for each pixel in the image data. The opacity data α2 is supplied to the multiplier 27. The multiplier 27 multiplies each of the luminance signal Y, and the color difference signals Cb and Cr in the YCbCr data input from the RGB/YCbCr conversion circuit 26B by the opacity data α2. The multiplied result from the multiplier 27 is input to one input end of an adder 28. In addition, a complement number (1−α2) of the opacity data α2 is supplied to the multiplier 25.

The multiplier 25 multiplies the added result from the adder 24 by the complement number (1−α2) of the opacity data α2. The multiplied result from the multiplier 25 is input to the other end of the adder 28, and is added to the above-described multiplied result from the multiplier 27. Thereby, the interactive graphics plane 12 is further synthesized with the synthesized result of the moving image plane 10 and the caption_plane 11.

In the caption plane 11 and the interactive graphics plane 12, for example, by setting the opacity α=0 of a region where there is no image to be displayed, planes displayed under the plane can be transparently displayed, and, thus, for example, moving image data displayed on the moving image plane 10 can be displayed as a background of the caption plane 11 or the interactive graphics plane 12.

### 1-3. IG Stream

Next, an interactive graphics stream (IG stream) will be described. Here, an IG stream having a strong relationship with the present disclosure will be mainly described.

The IG stream is a stream of data used to display a menu as described above. For example, a button image used to display a menu is stored in the IG stream.

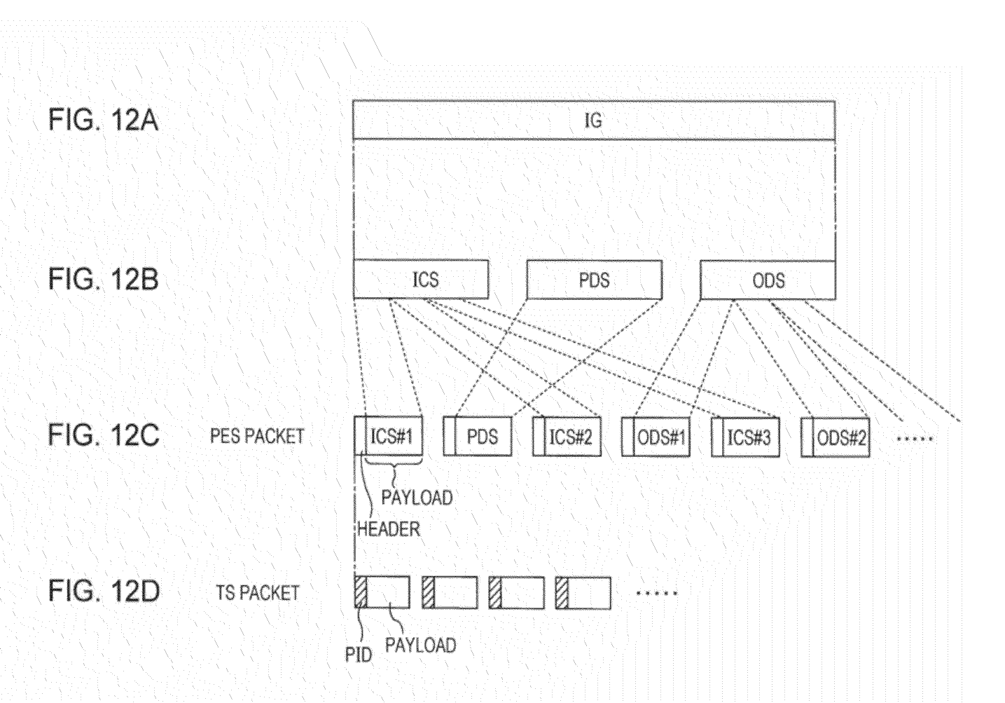

The IG stream is multiplexed into clip AV streams. The interactive graphics stream (refer to FIG. 12A) includes three segments, an ICS (Interactive Composition Segment), a PDS (Palette Definition Segment), and an ODS (Object Definition Segment) as exemplified in FIG. 12B.

The ICS among the three segments is a segment for maintaining a basic structure of the IG (interactive graphics) and will be described later in detail.

The PDS is a segment for maintaining color information of a button image.

In addition, the ODS is information for maintaining a shape of a button image. More specifically, in the ODS, a button image itself, for example, bitmap data for displaying the button image undergoes compression coding by a predetermined compression coding method such as run-length compression for storage.

As shown in FIG. 12C as an example, the ICS, the PDS, and the ODS are respectively divided into predetermined segments as necessary, are differentiated from each other by PID (Packet Identification), and are stored in payloads of PES (Packetized Elementary Stream) packets.

Since the size of the PES packet is set to 64 KB (kilobyte), the ICS and the ODS having the relatively large size are divided into predetermined segments, which are packed into the payloads of the PES packets. On the other hand, the PDS has the size smaller than 64 KB in most cases, and thus a PDS corresponding to one IG can be stored in one PES packet. In each of the PES packets, identification information indicating which one of the ICS, the PDS, and the ODS data stored in the payloads is or a sequence for each packet, is stored in the PID.

Each of the PES packets is further divided into predetermined packets, and is packed into a transport packet by an MPEG TS (Transport Stream) (FIG. 12D). Identification information or the like for identifying a sequence for each transport packet or data stored in the transport packet is stored in the PID.

Next, the ICS included in a display set of the interactive graphics will be described.

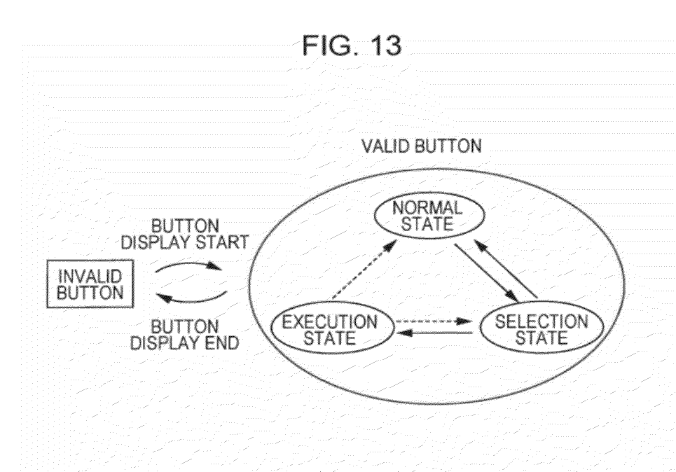

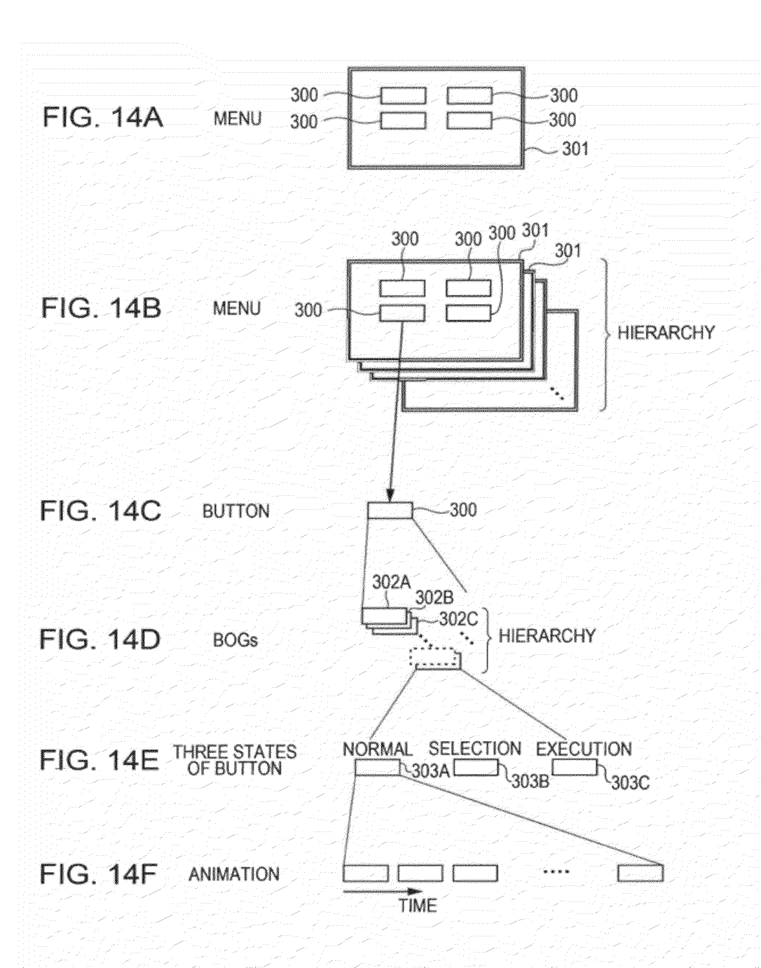

Prior to description of the ICS, first, the configurations of a menu screen and buttons will be described briefly with reference to FIGS. 13 to 14F. In addition, the display set is a data set for performing menu display, and the display set of the IG stream is constituted by the above-described ICS, PDS, and ODS.

FIG. 13 is an exemplary state transition diagram of a button displayed on the graphics plane 12. A button has two states of an invalid state and a valid state when generally classified. The button is not displayed on a screen in the invalid state, and the button is displayed on the screen in the valid state. Transition is performed from the invalid button state to the valid button state, and thereby button display starts. Transition is performed from the valid button state to the invalid button state, and thereby the button display finishes. The valid button state further has three states, a normal state (non-selection state), a selection state, and an execution state. The button display may be transitioned among the three states. The transition direction may be limited to one direction. Animation may be defined for each of the three button display states.

FIGS. 14A to 14F schematically show configurations of a menu screen and buttons. As exemplified in FIG. 14A, a menu screen 301 on which a plurality of buttons 300, 300, . . . are disposed is assumed.

The menu screen 301 may be hierarchically configured by a plurality of menu screens as exemplified in FIG. 14B. Each of the menu screens in each hierarchy is referred to as a page. For example, if the button 300 in the menu screen positioned at the top side is transitioned from a selection state to an execution state using a predetermined input portion, a menu screen positioned directly behind the menu screen may become a top menu screen.

In addition, in the specification, “a button state is made to vary using a predetermined input portion” is appropriately denoted by “a button is operated” or the like for convenience.

A single button 300 displayed on the menu screen 301 may have a hierarchical configuration of a plurality of buttons 302A, 302B, . . . (refer to FIGS. 14C and 14D). In other words, this means that a plurality of buttons can be selectively displayed at one button display position. For example, in a case where functions and display of several other buttons which are simultaneously displayed are changed when a predetermined button of a plurality of buttons is operated, the hierarchical configuration may be appropriately used because it is not necessary to renew the menu screen itself. A set formed by a plurality of buttons which are selectively displayed at one button position is referred to as a BOG (Button Overlap Group).

Each of the buttons forming one BOG may have three states, a normal state, a selection state, and an execution state. In other words, as exemplified in FIG. 14E, buttons 303A, 303B and 303C respectively indicating the normal state, the selection state, and the execution state may be prepared for each of the buttons forming the BOG. Further, as exemplified in FIG. 14F, animation display may be set to each of the buttons 303A, 303B and 303C indicating the three states. In this case, a button to which animation display is set includes the number of button images used for the animation display.

In addition, hereinafter, each of a plurality of button images used for the animation of a button is appropriately referred to as an animation frame.

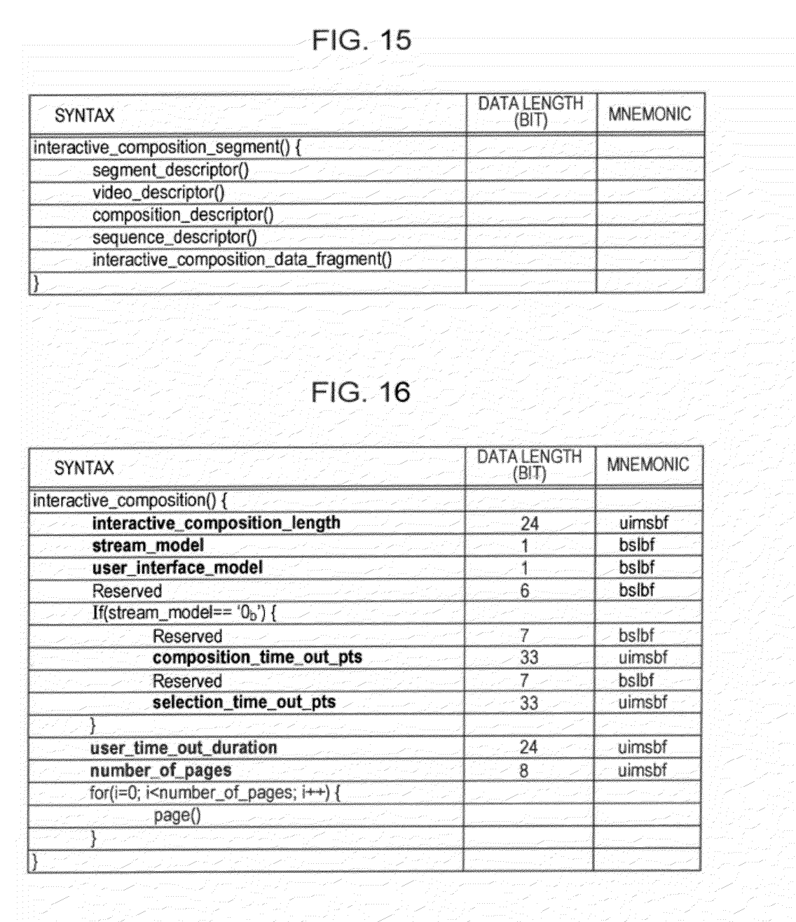

FIG. 15 shows a syntax indicating an exemplary structure of header information of the ICS. A header of the ICS includes a block segment_descriptor( ), a block video_descriptor( ), a block composition_descriptor( ), a block sequence_descriptor( ), and a block interactive_composition_data_fragment. The block segment_descriptor( ) indicates that this segment is an ICS. The block video_descriptor( ) indicates a frame rate or an image frame size of a video which is displayed at the same time as this menu. The block composition_descriptor( ) includes a field composition_state (not shown), and indicates a status of the ICS. The block sequence_descriptor( ) indicates whether or not the ICS extends over a plurality of PES packets.

More specifically, the block sequence_descriptor( ) indicates whether or not an ICS included in a current PES packet is positioned at the head or the tail of one IG stream.

That is to say, as described above, in relation to the PES packet of which the data size is fixed to 64 KB, if the data size of the ICS is large, the ICS is divided into predetermined segments which are respectively packed into the PES packets. At this time, the header part shown in FIG. 15 may be present in the leading and end PES packets among the PES packets into which the divided ICS are packed, and may be omitted in the PES packets in the middle. If the block sequence_descriptor( ) indicates both the head and the tail, it can be seen that the ICS is packed into one PES packet.

FIG. 16 shows a syntax indicating an exemplary structure of the block interactive_composition_data_fragment( ). In addition, in FIG. 16, the block itself is indicated by a block interactive_composition( ). A field intaractive_composition_length has the data length of 24 bits, and indicates the length after the field intaractive_composition_length of the block interactive_composition( ). The field stream_model has the data length of 1 bit, and indicates whether or not the stream is multiplexed.

If a value of the field stream_model is “0”, it indicates multiplex, and indicates a possibility that other elementary streams commonly related to the interactive graphics stream may be multiplexed in the MPEG2 transport stream. If a value of the field stream_model is “1”, it indicates non-multiplex, and indicates that only the interactive graphics stream is present in the MPEG2 transport stream. In other words, the interactive graphics stream may be multiplexed into AV streams, or may form a clip AV stream singly. In addition, a non-multiplex interactive graphics stream is defined only as a asynchronous sub-path.

The field user_interface_model has the data length of 1 bit, and indicates whether a menu displayed by the stream is a pop-up menu or a normally displayed menu. The pop-up menu is a menu of which the presence or absence of display can be controlled using a predetermined input portion in such a manner as, for example, ON or OFF of a button of a remote controller. On the other hand, the normally displayed menu is a menu of which the presence or absence of display may not be controlled by a user operation. If the field user_interface_model has a value of “0”, it indicates the pop-up menu, and if “1”, it indicates the normally displayed menu. In addition, the pop-up menu is allowed only in a case where the field stream_model has a value of “1” and the stream is not multiplexed with other elementary streams.

If the field stream_model has a value of “0”, a field composition_time_out_pts and a field selection_time_out_pts subsequent to an if statement If(stream_model==‘0b’) become valid. The field composition_time_out_pts has the data length of 33 bits and indicates a time point when the menu display disappears. In addition, the field selection_time_out_pts has the data length of 33 bits and indicates a time point when a selection operation in the menu display is disabled. The time points are respectively described by a PTS (Presentation Time Stamp) prescribed in MPEG2.

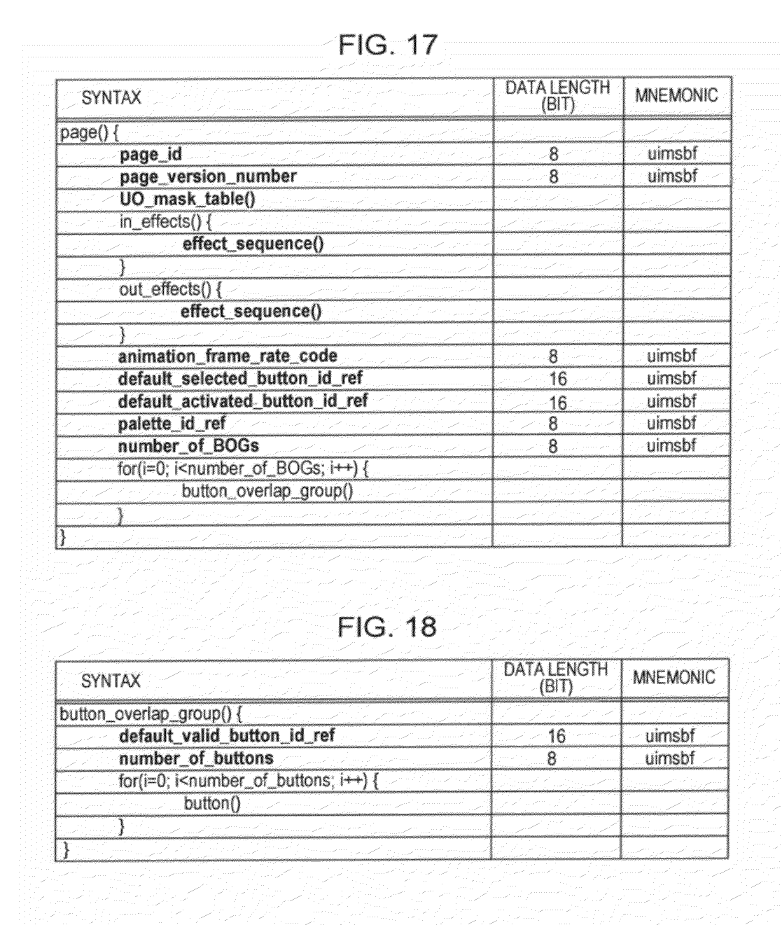

FIG. 17 shows a syntax indicating an exemplary structure of a block page( ). A field page_id has the data length of 8 bits and indicates ID for identifying this page. A field page_version_number has the data length of 8 bits and indicates a version number of this page. A subsequent block UO_mask_table( ) indicates a table where an operation for an input portion of a user (UO: User Operation), prohibited during display of the page, is described.

A block in_effect( ) indicates an animation block displayed when the page is displayed. A block effect_sequence( ) in the parenthesis { } describes an animation sequence. In addition, a block out_effect( ) indicates an animation block displayed when the page finishes. A block effect_sequence( ) in the parenthesis { } describes an animation sequence. The block in_effect( ) and the block out_effect( ) are animations executed in a case where the ICS is found when the page is moved.

A next field animation_frame_rate_code has the data length of 8 bits, and indicates a setting parameter of an animation frame rate when a button image of the page is animated. For example, when a frame rate of video data in a clip AV stream file corresponding to the ICS is Vform, and a corresponding animation frame rate is Aform, a value of the field animation_frame_rate_code can be expressed by such a ratio as Vfrm/Afrm.

A field default_selected_button_id_ref has the data length of 16 bits, and indicates ID for designating a button which initially enters a selection state when the page is displayed. In addition, a next field default_activated_button_id_ref has the data length of 16 bits, and indicates ID for designating a button which automatically enters an execution state when there comes a time indicated by the field selection_time_out_pts described with reference to FIG. 16.

A field palette_id_ref has the data length of 8 bits, and indicates the ID of a palette referred to by the page. In other words, color information in the PDS in the IG stream is designated by the field palette_id_ref.

A next field number_of_BOGs has the data length of 8 bits, and indicates the number of BOGs used in the page. In other words, the number_of_BOGs indicates the number of positions of BOGs to be displayed in the page, and, in short, indicates the number of buttons to be displayed (simultaneously displayed number) in the page.

Each of the BOGs is defined by a block button_overlap_group( ).

FIG. 18 shows a syntax indicating an exemplary structure of the block button_overlap_group( ). A field default_valid_button_id_ref has the data length of 16 bits, and indicates ID of a button which is initially displayed in a BOG defined by the block button_overlap_group( ). A next field number_of_buttons has the data length of 8 bits, and indicates the number of buttons used in the BOG. A loop from a subsequent for statement is repeated by the number indicated by the field number_of_buttons, and each of the buttons is defined by a block button( ).

That is to say, as described above, the BOG can have a plurality of buttons, and a structure of each of a plurality of buttons belonging to the BOG is defined by the block button( ). A button structure defined by the block button( ) is a button which is actually displayed.

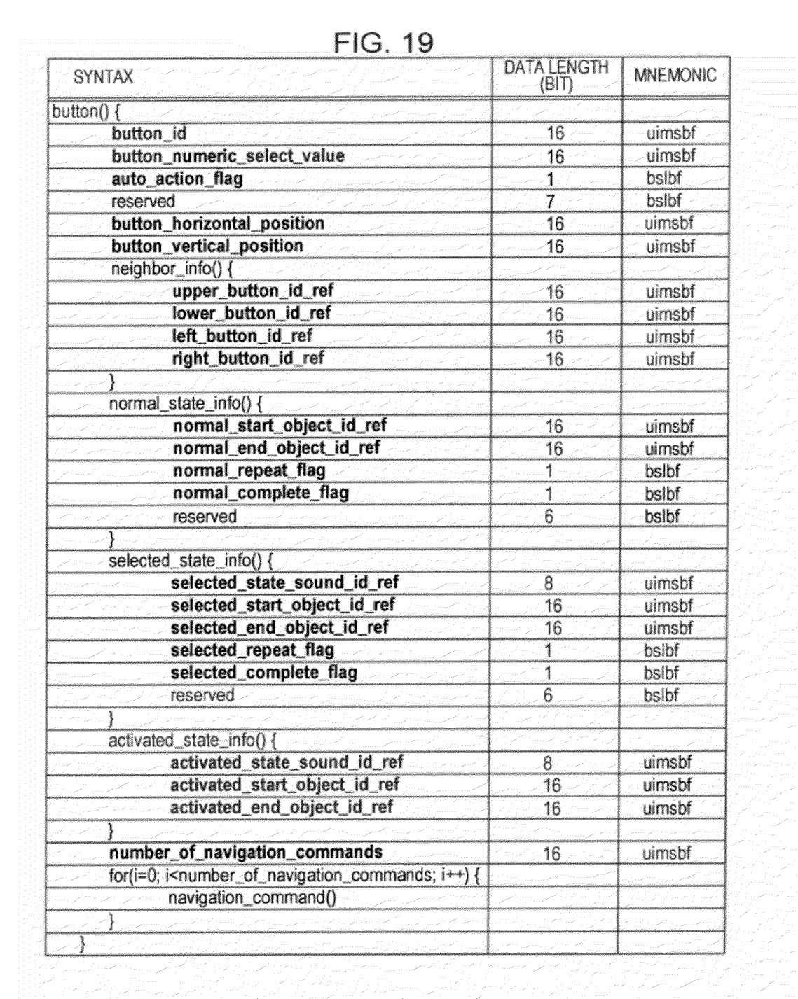

FIG. 19 shows a syntax indicating an exemplary structure of the block button( )

In FIG. 19, a field button_id has the data length of 16 bits, and indicates ID for identifying this button.

A field button_numeric_select_value has the data length of 16 bits, and indicates to which number of numeric keys on a remote controller the button is allocated.

A flag auto_action_flag is a flag having the data length of 1 bit, and indicates whether or not a function allocated to the button is automatically executed when the button enters a selection state.

In addition, hereinafter, a button defined such that a function allotted thereto is automatically executed by the flag auto_action_flag in the selection state is referred to as an automatic action button.

A field button_horizontal_position and a field button_vertical_position respectively have the data length of 16 bits, and indicate positions in the horizontal direction and the vertical direction on a screen, for displaying the button.

A block neighbor_info( ) indicates peripheral information of the button. In other words, the block neighbor_info( ) indicates which button is transitioned to a selection state, for example, from a state of the button which is in the selection state by a value therein, when direction keys indicating vertical and horizontal directions on the remote controller are operated.

A field upper_button_id_ref, a field lower_button_id_ref, a field left_button_id_ref, and a field right_button_id_ref, which are fields in the block neighbor_info( ) and each of which has the data length of 16 bits, respectively indicate IDs of buttons which are transitioned to a selection state when operations instructing the upper direction, the lower direction, the left direction, and the right direction are performed.

The following block normal_state_info( ), block selected_state_info( ), and block activated_state_info( ) respectively indicate information for buttons which are in a normal state (non-selection state), a selection state, and an execution state.

First, the block normal_state_info( ) will be described. A field normal_start_object_id_ref and a field normal_end_object_id_ref each having the data length of 16 bits respectively indicate IDs for designating start and end objects of animation of the button in the normal state. In other words, a button image (that is, an animation frame) used for animation display of a button is designated to a corresponding ODS by the field normal_start_object_id_ref and the field normal_end_object_id_ref.

A following flag normal_repeat_flag is a flag having the data length of 1 bit, and indicates whether or not animation of the button is repeated. For example, the flag normal_repeat_flag indicates non-repetition at a value of “0”, and indicates repetition at a value of “1”. A following flag normal_complete_flag is a flag having the data length of 1 bit, and controls an animation operation when the button is transitioned to a selection state from a normal state.

Next, the block selected_state_info( ) will be described. The block selected_state_info( ) additionally has a field selected_state_sound_id_ref for instructing sound as compared with the above-described block normal_state_info( ). The field selected_state_sound_id_ref has the data length of 8 bits, and indicates a sound file reproduced for the button in the selection state. For example, the sound file is used as a sound effect when the button is transitioned from the normal state to the selection state.

A field selected_start_object_id_ref and a field selected_end_object_id_ref each of which has the data length of 16 bits respectively indicate IDs for designating start and end objects of animation of the button in the selection state.

A following flag selected_repeat_flag having the data length of 1 bit indicates whether or not animation of the button is repeated. For example, the flag indicates non-repetition at a value of “0”, and indicates repetition at a value of “1”.

A following flag selected_complete_flag is a flag having the data length of 1 bit. The flag selected_complete_flag is a flag for controlling an animation operation when the button is transitioned to other states from the selection state. In other words, the flag selected_complete_flag can be used in a case where the button is transitioned to an execution state from the selection state and in a case where the button is transitioned to a normal state from the selection state.

As described above, if the flag selected_complete_flag has a value of “1”, animations defined as the selection state are all displayed when the button is transitioned from the selection state to other states. More specifically, if a value of the flag selected_complete_flag is “1”, when an input for transitioning the button to other states from the selection state during the animation display for the selection state of the button is performed, animation display is performed from an animation frame displayed at that time to an animation frame indicated by the above-described field selected_end_object_id_rte.

In addition, a value of the flag selected_complete_flag is “1” and the flag selected_repeat_flag indicates repetition (for example, a value “1”) as well, animation display is performed from an animation frame displayed at that time to an animation frame indicated by the above-described field selected_end_object_id_ref.

In this case, for example, even in a case where a state comes where a button may not be selected or button display itself is erased, if a time point transitioned to such a state is during the animation display, animation display is performed up to the animation frame indicated by the field selected_end_object_id_ref, and then a button state is transitioned.

The state where a button may not be selected may be a case where a state comes where a button may not be selected through the designation of the above-described field selection_time_out_pts, or may be a case where a menu is automatically initialized through the designation of the field user_time_out_duration.

On the other hand, if a value of the flag selected_complete_flag is “0”, the animation defined in the button in the selection state is not displayed up to the animation frame indicated by the field selected_end_object_id_ref when the button is transitioned from the selection state to other states, but the animation display stops at the time when the transition of states is instructed, and a button in another state is displayed.

In the block activated_state_info( ), a field activated_state_sound_id_ref has the data length of 8 bits, and indicates a sound file reproduced for the button in the execution state. A field activated_start_object_id_ref and a field activated_end_object_id_ref each having the data length of 16 bits respectively indicate IDs for designating start and end animation frames (that is, button images) of the animation of the button in the execution state. If the field activated_start_object_id_ref and the field activated_end_object_id_ref refer to the same button image, it indicates that only one button image can be correlated with the button in the execution state.

The field activated_start_object_id_ref or the field activated_end_object_id_ref indicates that a button image is not designated at a value of [0xFFFF]. For example, if a value of the field activated_start_object_id_ref is [0xFFFF], and a value of the field activated_end_object_id_ref indicates a valid button image, a button image is not correlated with the button in the execution state. In addition, if a value of the field activated_start_object_id_ref indicates a valid button image, and a value of the field activated_end_object_id_ref is [0xFFFF], the button may be treated as being invalid.

The description of the block activated_state_info( ) is completed. The following field number_of_navigation_commands has the data length of 16 bits, and indicates the number of commands embedded in the button.

The loop is repeated from a subsequent for statement by the number indicated by the field number_of_navigation_commands, and thereby a command navigation_command( ) executed by the button is defined. In other words, this means that a plurality of commands can be executed from one button.

### 1-4. Model of IG Decoder

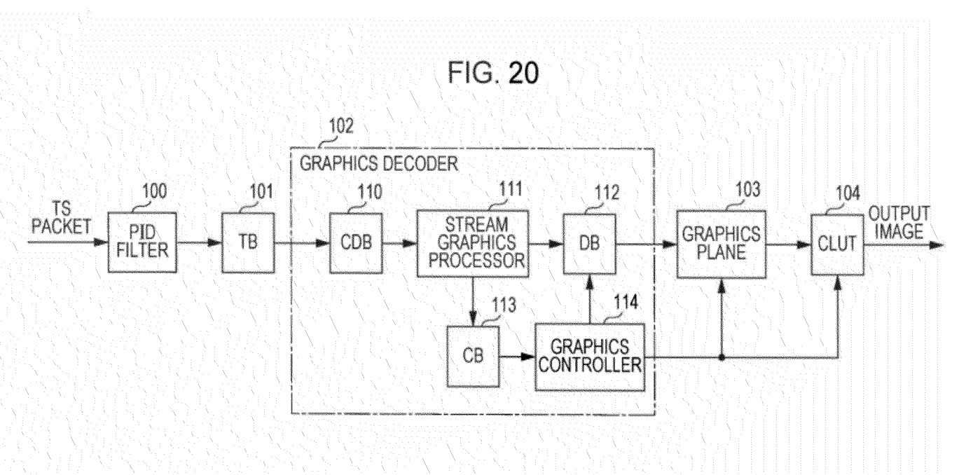

Next, a decoder model of interactive graphics (appropriately abbreviated to IG) will be described with reference to FIG. 20. In addition, a configuration shown in FIG. 20 may be used to decode interactive graphics and also used in common to decode presentation graphics.

First, a disc is loaded onto a player, an index file “index.bdmv” and a movie object file “MovieObject.bdmv” are read from the disc, and thereby a predetermined top menu is displayed. When a title to be reproduced is indicated based on display of the top menu, a play list file for reproducing the indicated title is invoked by a corresponding navigation command in the movie object file. Further, a clip AV stream file which is requested to be reproduced from the play list according to description of the play list file, that is, an MPEG2 transport stream is read from the disc.

The transport stream is supplied to a PID filter 100 as a TS packet and then PID is interpreted. The PID filter 100 sorts the supplied TS packet according to video data, audio data, menu data, and sub-title (caption) data stored therein.

If the PID indicates the menu data, that is, interactive graphics, or if the PID indicates presentation graphics, the configuration in FIG. 20 is effective.

In addition, the presentation graphics has no relation with the present disclosure, and thus description thereof will be omitted.

In the PID filter 100, the TS packets storing data corresponding to the decoder model are selected from the transport stream, and are packed into a transport buffer (hereinafter, referred to as a TB) 101. Data is extracted from payloads of the TS packets in the TB 101. Data which can configure a PES packet is packed into the TB 101, and then a PES packet is reconstructed based on the PID. That is to say, the respective segments distributed to the TS packets are unified.

The PES packets formed by the segments are supplied to a decoder 102 in an elementary stream format after PES headers are removed, and are temporarily packed into a CDB (Coded Data Buffer) 110. If there are elementary streams reaching a time point shown in a corresponding DTS among the elementary streams packed in the CDB 110 based on an STC, corresponding segments are read from the CDB 110 and are transmitted to a stream graphics processor 111 so as to be respectively decoded, and then are developed on segments.

The stream graphics processor 111 stores the decoded segments in a DB (Decoded Object Buffer) 112 or a CB (Composition Buffer) 113 in a predetermined manner. A type of segment having the DTS such as a PCS, an ICS, a WDS, and an ODS is stored in the DB 112 or the CB 113 at a timing shown in a corresponding DTS. In addition, a type of segment which does not have the DTS such as a PDS is instantly stored in the CB 113.

A graphics controller 114 controls the segments. The graphics controller 114 reads an ICS from the CB 113 at a timing shown in a corresponding PTS and reads a PDS referred to by the corresponding ICS. In addition, the graphics controller 114 reads an ODS referred to by the corresponding ICS from the DB 112. The graphics controller 114 decodes the read ICS and ODS so as to form data for displaying a menu screen such as button images, and writes the data in a graphics plane 103.

In addition, the graphics controller 114 decodes the PDS read from the CB 113 so as to form a color palette table as described with reference to FIG. 11, and writes the table in a CLUT 104.

An image written in the graphics plane 103 is read at a predetermined timing, for example, a frame timing, and forms output image data by referring to the color palette table in the CLUT 104 and adding color information, and the output image data is output.

1-5. Synthesized Display of Menu Image with Video Stream

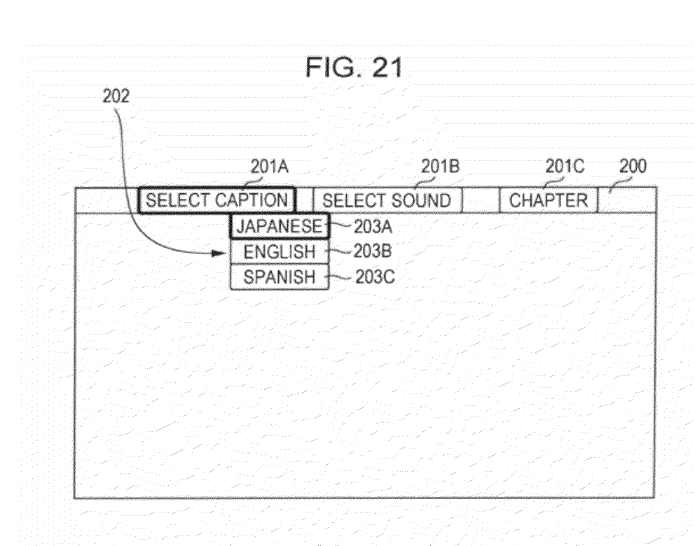

With reference to FIGS. 21 to 23, an example where a menu image by an IG stream is synthesized with a video stream reproduced based on a play list of a main path for display will be described briefly.

FIG. 21 shows an exemplary menu image displayed by an IG stream. In this example, a background 200 of a menu is displayed, and a button 201A, a button 201B, and a button 201C are displayed, by the IG stream. A normal state, a selection state, and an execution state may be prepared for each of the buttons 201A, 201B and 201C. The background 200 of the menu is prohibited from being moved, and is displayed by buttons to which commands are not set (referred to as special buttons). In addition, the respective buttons have a limitation that they may not be displayed in an overlapping manner. For this reason, independent special buttons are respectively disposed at parts between the respective buttons 201A, 201B and 201C, a left part of the button 201A, and a right part of the button 201C.

For example, if the right side or the left side is indicated through an operation of direction indication keys (direction keys) such as cross keys on a remote controller, the buttons 201A, 201B and 201C sequentially alter and display a button image in a normal state and a button image in a selection state in response to the operation. Further, in the example shown in FIG. 21, when the button is in a selection state, a pull-down menu 202 corresponding to the button in the selection state is displayed through an operation indicating a lower direction using the cross keys, or an operation of a determination key.

The pull-down menu 202 includes, for example, a plurality of buttons 203A, 203B and 203C. A normal state, a selection state, and an execution state may be prepared for each of the plurality of buttons 203A, 203B and 203C in a manner similar to the buttons 201A, 201B and 201C.

If the upper side or the lower side is indicated through, for example, an operation of the cross keys in a state where the pull-down menu 202 is displayed, each of the buttons 203A, 203B and 203C sequentially alters and displays a button image in a normal state and a button image in a selection state in response to the operation.

In addition, for example, a button image in a selection state is switched to a button image in an execution state for display through an operation of the determination key, and a functional operation corresponding to a command allocated to the button is executed by the player.

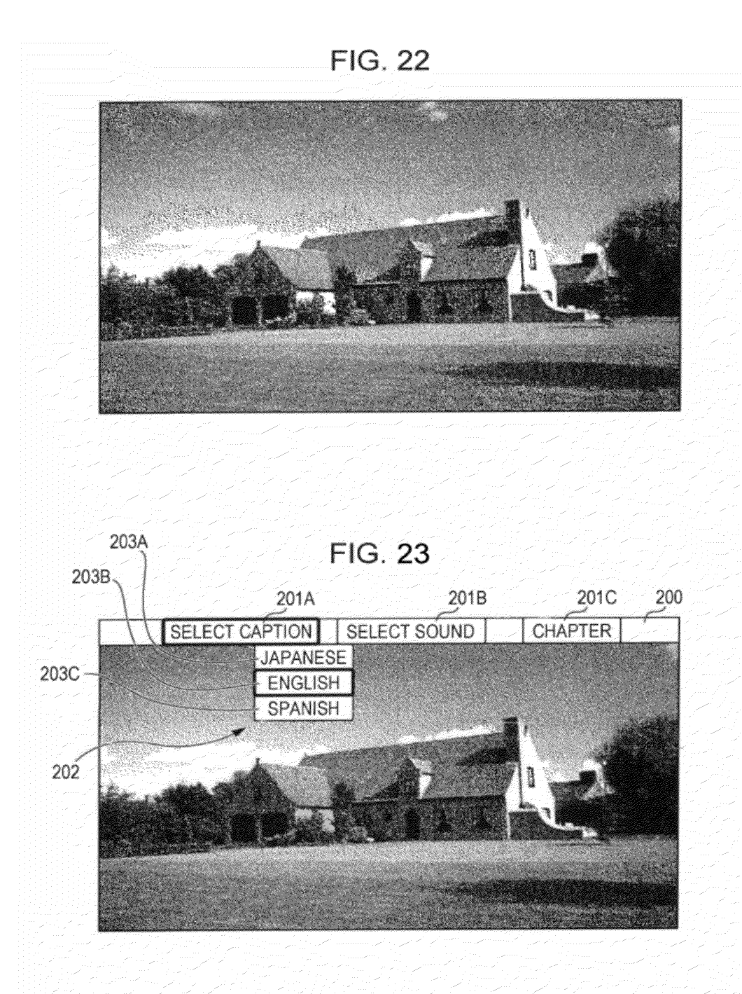

A case of synthesizing the menu image with moving image data, exemplified in FIG. 22, reproduced by the play item of the main path and displayed on the moving image plane 10 will be described.

In the screen of FIG. 21, the opacity a of a part other than the menu image including the menu image including the pull-down menu 202 part is set to “0”, and the interactive graphics plane 12 and the moving image plane 10 are synthesized with each other. Thereby, as exemplified in FIG. 23, it is possible to obtain display where the moving image data exemplified in FIG. 22 is synthesized with the menu image exemplified in FIG. 21.

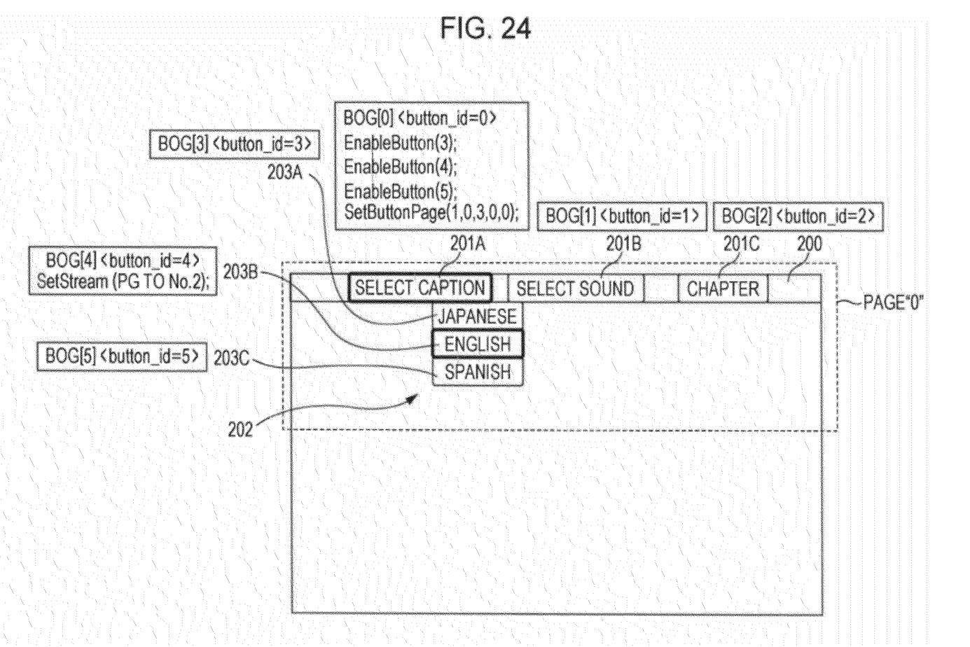

An example of a method for realizing the pull-down menu display in the above-described menu image will be described briefly. For example, an example where the pull-down menu 202 is displayed by operating the determination key on the remote controller when the button 201A is in a selection state will be described with reference to FIG. 24. In FIG. 24, parts common to those in FIG. 21 described above are given the same reference numerals and detailed description thereof will be omitted.

In the example shown in FIG. 24, it is assumed that a menu including the background 200, the buttons 201A, 201B and 201C, and the pull-down menu 202 is displayed on a menu screen indicated by a page “0”. The buttons 201A, 201B and 201C are assumed as a button overlap group (BOG) where values button_id which are IDs for identifying the buttons are defined by “1”, “2”, and “3”. In addition, the buttons 203A, 203B and 203C of the pull-down menu 202 corresponding to the button 201A are assumed as a button overlap group where values button_id are defined by “3”, “4”, and “5”.

In the block button( ) defining the button 201A, for example, the following command is described in the command navigation_command( ) part executed by the button 201A. Each command described below is a command defined by a BD-ROM logical format.

EnableButton(3); EnableButton(4); EnableButton(5); SetButtonPage(1,0,3,0,0);

In this command, the command EnableButton( ) indicates that a button where a value shown in the parenthesis “( )” is defined as a value button_id is made to enter an enable state (valid state). In addition, in contrast to the command EnableButton( ) which makes a button enter a valid state, a command DisableButtom( ) is used to make a button enter a disable state, that is, an invalid state.

The command SetButtonPage( ) is a command which allows a button which enters a valid state by, for example, the command EnableButton( ) to be selected. The command SetButtonPage( ) includes five parameters, a parameter button_flag, a parameter page_flag, a parameter button_id, a parameter page_id, and a parameter out_effect_off_flag. The parameter button_flag indicates that a value of the parameter button_id which is the third parameter is set to a memory (PSR: Player Status Register) which is included in the player and is used to manage a reproduction state. The parameter page_flag indicates whether or not a value page_id held in the PSR and used to identify a page is changed into the parameter page_id which is the fourth parameter. In addition, the parameter out_effect_off_flag indicates whether or not effect defined by the button 201A is executed when the button 201A enters a non-selection state.

In addition, for the buttons 203A, 203B and 203C forming the pull-down menu 202, a command navigation_command( ) executed when the buttons are in a determination state is described. In the example shown in FIG. 24, for the button 203B, a command SetStream( ) for setting a stream to be used is described. This example shows a case where a second PG stream is used by the command SetStream( ).

The above-described command navigation_command( ) described for each button is only an example, and the present disclosure is not limited thereto. For example, the command SetStream( ) may be described for the buttons 203A and 203C of the pull-down menu 202 for selecting a caption, in a manner similar to the above button 203B.

If the determination key is operated in a selection state of the button 201A on the menu screen exemplified in FIG. 24, buttons where values button_id are defined by “3”, “4”, and “5”, that is, the buttons 203A, 203B and 203C of the pull-down menu 202 enter a valid state, and a corresponding button image is displayed. At this time, the button 203A where a value button_id is indicated as “3” enters a selection state based on the description of the command SetButtonPage(1,0,3,0,0).

Further, if the lower direction is indicated through an operation of the cross keys or the like, a focus on the buttons is moved downwardly such that the button 203A is transitioned from the selection state to the normal state, and the button 203B is transitioned from the normal state to the selection state. When the determination key is operated in this state, the second PG stream is selected and then caption display is switched to an English caption according to the description of the command navigation_command( ) in the button 203B.

### 1-6. Hidden Button

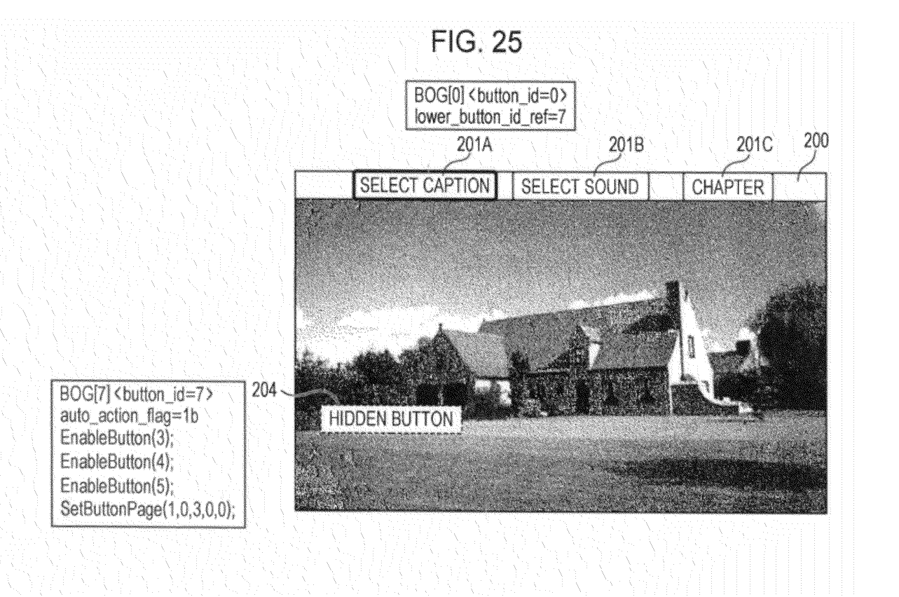

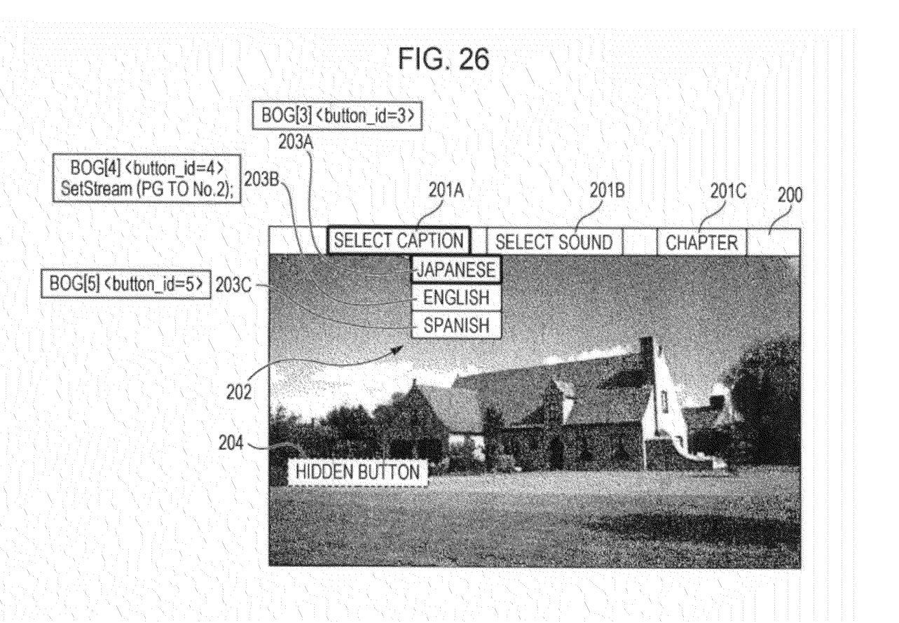

As another example, an example where the pull-down menu 202 is display-ed by performing an operation for designating a lower direction using the cross keys on the remote controller when the button 201A is in a selection state will be described with reference to FIGS. 25 and 26.

This example is an example using a hidden button.

In FIGS. 25 and 26, moving image data displayed on the moving image plane 10 by the play item of the main path is synthesized with the menu image.

In FIGS. 25 and 26, parts common to FIGS. 21, 23, 24, and the like are given the same reference numerals, and description thereof will be omitted. For example, it is assumed that values button_id of the buttons 203A, 203B and 203C of the pull-down menu 202 shown in FIG. 26 are defined by “3”, “4”, and “5”, and the command SetStream( ) using the second PG stream is described for the button 203B.

When the pull-down menu 202 is displayed using the downward key instead of the determination key in a selection state of the button, there may be a method of using a hidden button 204 which is not seen by a user as exemplified in FIGS. 25 and 26. The hidden button 204 can be realized by, for example, designating the opacity α=0 with respect to button image data correlated with the hidden button 204.

In FIGS. 25 and 26, although the hidden button 204 is indicated with the dotted frame for description, in practice, the hidden button 204 is not displayed, and an image on a rear plane (for example, the moving image plane 10) is transmitted and displayed.

In FIG. 25, it is assumed that, in the block button( ) defining the hidden button 204, a value button_id for identifying the hidden button 204 is, for example, “7”, and the hidden button 204 is a button overlap group where the value button_id 7 is defined by “7”. Further, in the block button( ), a value of the flag auto_action_flag is set to, for example, “1b” (“b” indicates that a previous numerical value is a binary value) and thereby the hidden button 204 is defined so as to be automatically transitioned from a selection state to an execution state. In addition, for example, the following command is described in the command navigation_command( ) part executed by the hidden button 204.

EnableButton(3); EnableButton(4); EnableButton(5); SetButtonPage(1,0,3,0,0);

On the other hand, for example, a value of the field lower_button_id_ref is set to “7” for the button 201A for selecting captions, and if a lower direction is designated through an operation of the cross keys in a section state of the button 201A, a button (in this example, the above-described hidden button 204) having a value of the button_id of “7” is set to be transitioned to a selection state.

If a lower direction is indicated through an operation of the cross keys or the like when the button 201A is in a selection state on the menu display exemplified in FIG. 25, the hidden button 204 indicated by the value button_id of “7” enters a selection state according to the description of the field lower_button_id_ref in the button 201A. Here, the hidden button 204 is defined by the flag auto_action_flag so as to be automatically transitioned from a selection state to an execution state. For this reason, buttons where the values button_id are defined by “3”, “4”, and “5”, that is, the buttons 203A, 203B and 203C of the pull-down menu 202 respectively enter a valid state, and corresponding button images are displayed, according to the description of the command EnableButton( ) of the command navigation_command( ) part in the hidden button 204 (refer to FIG. 26). At this time, based on the description of the command SetButtonPage(1,0,3,0,0), the button 203A where the value button_id is indicated as “3” enters a selection state.

In addition, if a lower direction is indicated through an operation of the cross keys or the like, a focus on the buttons is moved such that the button 203A is transitioned from the selection state to a normal state, and the button 203B is transitioned from the normal state to a selection state. When the determination key is operated in this state, the second presentation graphics stream is selected and then caption display is switched to an English caption according to the description of the command navigation_command( ) in the button 203B.

### 2. Configuration of Reproduction Device

Next, an overall configuration of a reproduction device 1 which is the information processing device according to an embodiment of the present disclosure will be described.

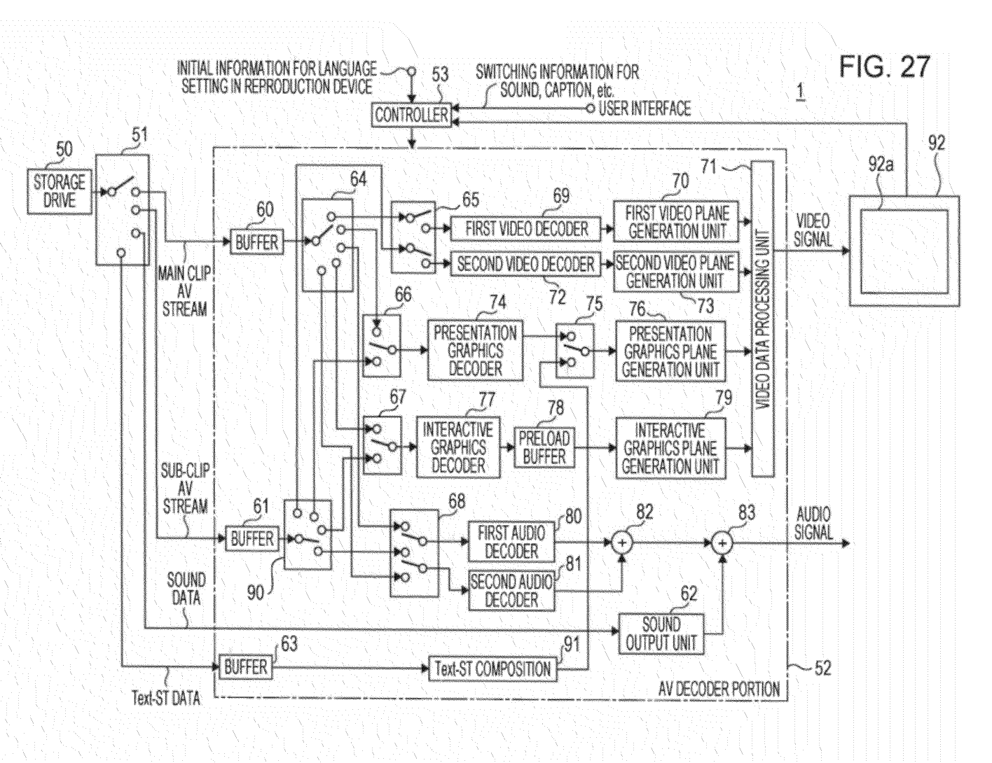

FIG. 27 is a diagram illustrating an overall internal configuration of the reproduction device 1.

In FIG. 27, the reproduction device 1 may include a storage drive 50, a switch unit 51, an AV decoder portion 52, a controller 53, and a display 92 having a touch panel 92a.

The storage drive 50 can seat, for example, the above-described BD-ROM thereon and reproduce the BD-ROM.

In the reproduction device 1 according to the embodiment, not only an operation input using the above-described remote controller but also an operation input using the touch panel 92a are possible, which will be described later.

The controller 53 includes, for example, a CPU (Central Processing Unit), a ROM (Read Only Memory) which stores programs executed on the CPU in advance, a RAM (Random Access Memory) used as a work memory when the programs are executed by the CPU, and the like, and controls overall operations of the reproduction device 1.

The reproduction device 1 includes a user interface unit which provides predetermined control information to a user and outputs a control signal in response to a user operation. Although not shown in detail, in this example, as the user interface unit, a remote controller is used which remotely communicates with the reproduction device 1 via a predetermined wireless communication portion such as infrared communication. A plurality of input portions such as direction keys such as cross keys capable of respectively indicating the vertical and horizontal directions, number keys (a so-called ten key), function keys to which various functions are allocated in advance, are provided on the remote controller. A shape of the direction keys may be arbitrary as long as they can respectively designate the vertical and horizontal directions.

The remote controller generates a control signal (operation input signal) in response to an operation performed using the input portion, and modulates the generated control signal, for example, into an infrared signal, and transmits the infrared signal. The reproduction device 1 receives the infrared signal using an infrared reception unit (not shown), converts the infrared signal into an electric signal so as to be demodulated, and restores the original control signal. The control signal is supplied to the controller 53.

The controller 53 controls an operation of the reproduction device 1 according to a program in response to the control signal.

In addition, the user interface unit is not limited to the remote controller, but, for example, may be constituted by a switch group provided on an operation panel of the reproduction device 1.

In addition, initial information for language setting of the reproduction device 1 is stored in a nonvolatile memory or the like included in the reproduction device 1. The initial information for language setting is read from the memory and is supplied to the controller 53, for example, when the reproduction device 1 is powered on, or the like.

When a disc is loaded onto the storage drive 50, the controller 53 reads the file index.bdmv or the file MovieObject.bdmv from the disc via the storage drive 50, and reads a play list file in the directory “PLAYLIST” based on the description of the read file.

The controller 53 reads a clip AV stream referred to by a play item included in the play list file, from the disc via the storage drive 50. In addition, if the play list includes a sub-play item, the controller 53 also reads a clip AV stream referred to by the sub-play item or sub-title data from the disc via the storage drive 50.

Hereinafter, a clip AV stream corresponding to a sub-play item is referred to as a sub-clip AV stream, and a clip AV stream corresponding to a main play item with respect to a sub-play item is referred to as a main clip AV stream.

The data output from the storage drive 50 undergoes a demodulation process and an error correction process by a demodulation unit and an error correction unit (not shown), and thus a multiplex stream is restored. The multiplex stream here is a time-division multiplex transport stream where the kind or the arrangement order of data is identified by the PID, and the data is divided into data with a predetermined size. The multiplex stream is supplied to the switch unit 51. The controller 53 controls the switch unit 51 in a predetermined manner based on, for example, the PID, so as to sort the data for each kind, supplies packets of the main clip AV stream to a buffer 60, supplies packets of the sub-clip AV stream to a buffer 61, supplies packets of sound data to a sound output unit 62, and supplies packets of text data to a buffer 63.

The packets of the main clip AV stream packed into the buffer 60 are read from the buffer 60 for each packet under the control of the controller 53, and are supplied to a PID filter 64. The PID filter 64 divides the packets into packets by a video stream, packets by a presentation graphics stream (hereinafter, a PG stream), packets by an interactive graphics stream (IG stream), and packets by an audio stream, based on the PID of the supplied packet.

The packets of the sub-clip AV stream packed into the buffer 61 are read from the buffer 61 for each packet under the control of the controller 53, and are supplied to a PID filter 90. The PID filter 90 divides the packets into packets by the video stream, packets by the PG stream, packets by the IG stream, and packets by the audio stream, based on the PID of the supplied packet.

The packets by the video stream divided by the PID filter 64 and the packets by the video stream divided by the PID filter 90 are supplied to a PID filter 65, and are divided depending on the PID. In other words, the PID filter 65 divides the packets so as to supply the packets by the main clip AV stream supplied form the PID filter 64 to a first video decoder 69 and supply the packets by the sub-clip AV stream supplied from the PID filter 90 to a second video decoder 72.

The first video decoder 69 extracts a video stream from payloads of the supplied packets, and decodes compression coding by the MPEG2 method of the extracted video stream. An output from the first video decoder 69 is supplied to a first video plane generation unit 70 and a video plane is generated. The video plane is generated by, for example, writing one frame of digital video data in a baseband in a frame memory. The video plane-generated by the first video plane generation unit 70 is supplied to a video data processing unit 71.

In a second video decoder 72 and a second video plane generation unit 73, substantially the same processes as in the first video decoder 69 and the first video plane generation unit 70 described above are performed, such that a video stream is decoded, and a video plane is generated. The video plane generated by the second video plane generation unit 73 is supplied to the video data processing unit 71.

The video data processing unit 71 may insert the video plane generated by the first video plane generation unit 70 and the video plane generated by the second video plane generation unit 73 into one frame, for example, in a predetermined manner, thereby generating one video plane. The video plane may be generated by selectively using the video plane generated by the first video plane generation unit 70 and the video plane generated by the second video plane generation unit 73. The video plane corresponds to, for example, the moving image plane 10 exemplified in FIG. 9.

The packets by the PG stream divided by the PID filter 64 and the packets by the PG stream divided by the PID filter 90 are supplied to a switch unit 66, and one of both the two is selected in a predetermined manner and is supplied to a presentation graphics decoder 74. The presentation graphics decoder 74 generates graphics data for displaying a caption by extracting a PG stream from payloads of the supplied packets and decoding the PG stream in a predetermined manner, and supplies the generated graphics data to a switch unit 75.

The switch unit 75 selects either the graphics data or caption data by text data described later in a predetermined manner so as to be supplied to a presentation graphics plane generation unit 76. The presentation graphics plane generation unit 76 generates a presentation graphics plane based on the supplied data, so as to be supplied to the video data processing unit 71. The presentation graphics plane corresponds to, for example, the caption plane 11 exemplified in FIG. 9.

The packets by the IG stream divided by the PID filter 64 and the packets by the IG stream divided by the PID filter 90 are supplied to a switch unit 67, and one of both the two is selected in a predetermined manner and is supplied to an interactive graphics decoder 77. The interactive graphics decoder 77 extracts an ICS, a PDS and an ODS of the IG stream from the supplied packets by the IG stream for decoding in a predetermined manner. For example, the interactive graphics decoder 77 extracts data from payloads of the supplied packets and reconstructs a PES packet. In addition, the interactive graphics decoder 77 extracts the ICS, the PDS, and the ODS of the IG stream based on header information or the like of the PES packet. The decoded ICS and PDS are stored in a buffer called a CB (Composition Buffer). The ODS is stored in a buffer called a DB (Decoded Buffer). For example, a preload buffer 78 in FIG. 27 corresponds to the CB and the DB.

In addition, the PES packet includes a PTS (Presentation Time Stamp) which is time management information regarding a reproduction output and a DTS (Decoding Time Stamp) which is time management information regarding decoding. Time for menu display by the IG stream is managed by the PTS stored in a corresponding PES packet and the menu is displayed. For example, each piece of data forming the IG stream stored in the above-described preload buffer is controlled to be read at a predetermined time based on the PTS.

The data of the IG stream read from the preload buffer 78 is supplied to an interactive graphics plane generation unit 79, and an interactive graphics plane is generated. The interactive graphics plane corresponds to, for example, the graphics plane 12 exemplified in FIG. 9.

For example, when a displayed button state is transitioned from, for example, a selection state to an execution state in response to a predetermined operation using the input portion provided on the user interface unit, the interactive graphics decoder 77 controls display of a button image correlated with the execution state of the button based on the button image and sound data correlated with the execution state of the button.

As an example, in a case where display of a menu image is instructed through an operation of a predetermined key provided on the remote controller, if the display of the menu image is defined in a play item during reproduction, the menu image is controlled so as to be displayed after being synthesized with moving image data of the main path, based on data of a related IG stream. For example, the interactive graphics decoder 77 reads the decoded PDS, which is referred to by the decoded ICS stored in the CB, from the CB, and reads the corresponding decoded ODS from the DB, thereby forming data for displaying a button image.

In addition, the interactive graphics decoder 77 extracts a navigation command correlated with each button, from the decoded ICS stored in the CB. The extracted navigation command is forwarded to, for example, the controller 53. The controller 53 controls the respective parts of the reproduction device 1 in a predetermined manner based on the navigation command. Thereby, a functional operation corresponding to a command correlated with the button is realized.

The video data processing unit 71 includes, for example, the graphics processing unit described with reference to FIG. 10, and synthesizes the supplied video plane (the moving image plane 10 in FIG. 10), the presentation graphics plane (the caption plane 11 in FIG. 10), and the interactive graphics plane (the graphics plane 12 in FIG. 10) together in a predetermined manner, so as to generate a piece of image data, and outputs the data as a video signal.

The video signal is supplied to the display 92 as shown in the figure.

The display 92 displays an image based on the video signal on a display screen.

The audio stream divided by the PID filter 64 and the audio stream divided by the PID filter 90 are supplied to a switch unit 68. The switch unit 68 selects the supplied two audio streams in a predetermined manner such that one of the two is supplied to a first audio decoder 80 and the other thereof is supplied to a second audio decoder 81. The audio streams decoded by the first audio decoder 80 and the second audio decoder 81 are synthesized by an adder 82.

The sound output unit 62 includes a buffer memory, and packs the sound data supplied from the switch unit 51 into the buffer memory. In addition, for example, the sound output unit 62 decodes and outputs the sound data packed into the buffer memory based on an instruction from the interactive graphics decoder 77. The output sound data is supplied to an adder 83 and is synthesized with the audio stream output from the adder 82. A notification of a reproduction end time of the sound data is sent, for example, from the sound output unit 62 to the interactive graphics decoder 77. In addition, a cooperative control of reproduction of the sound data and display of the button image may be performed based on a command of the higher rank controller 53.

The text data read from the buffer 63 is processed by a Text-ST composition unit 91 in a predetermined manner and then is supplied to the switch unit 75.

In the above description, although an example where the respective parts of the reproduction device 1 are configured by hardware has been described, for example, the reproduction device 1 may be realized by processes on software. In this case, the reproduction device 1 can be operated on a computer device.

Alternatively, the reproduction device 1 may be realized by a configuration where hardware and software are mixed. For example, the respective decoders in the reproduction device 1, particularly, parts having larger loads than other parts, such as the first video decoder 69 and the second video decoder 72 may be configured by hardware, the other parts may be configured by software.

The reproduction device 1 is configured only by software, or a mixture of hardware and software, and a program executed by a computer device is recorded on a recording medium such as a CD-ROM (Compact Disc-Read Only Memory) or a DVD-ROM (Digital Versatile Disc Read Only Memory), and is provided. The recording medium is loaded onto a drive of the computer device, the program recorded on the recording medium is installed in the computer device in a predetermined manner, and thereby the above-described processes can be executed on the computer device. The program may be recorded on the BD-ROM. In addition, a configuration of the computer device is well known, and thus description thereof will be omitted.

### 3. Determination of Button Touch

Here, as described above, the reproduction device 1 according to the embodiment has a configuration where an operation input is possible using the touch panel 92a.

The touch panel 92a is provided on a display screen of the display 92, and outputs coordinate information indicating a touched position to the controller 53 as operation input information.

The controller 53 according to the embodiment performs determination (determination as to whether or not buttons are operated) of touch on buttons displayed on the screen in the following manner, in response to the operation input information from the touch panel 92a.

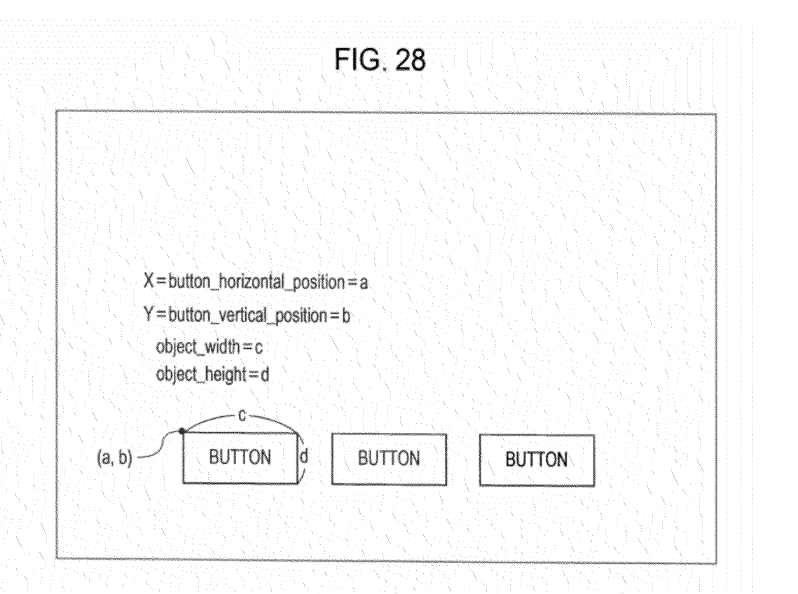

FIG. 28 is a diagram illustrating a detailed method of touch determination of buttons corresponding to the touch panel 92a.

As shown in the figure, when the touch determination of a button corresponding to operation input information from the touch panel 92a is performed, the button_horizontal_position and button_vertical_position information, and the object_width and object_height information are used among the information shown in FIG. 19.

As understood from the above description, the button_horizontal_position and button_vertical_position information is information indicating a position in the horizontal direction and a position in the vertical direction for displaying the button on a screen, and functions as coordinate information for indicating a displayed position of the button on the screen.

In addition, the object_width and object_height information is information indicating the size of the button, and indicates the length (width) of the button in the horizontal direction and the length (height) thereof in the vertical direction.

Here, the object_width and object_height information is transmitted by the ODS. Specifically, the information is stored in the object_data inside the ODS. The object_data is referred to via information indicating an object of the button such as, for example, the normal_start_object_id_ref or the normal_end_object_id_ref, shown in FIG. 19.

The controller 53 in this case obtains the button_horizontal_position information, the button_vertical_position information, the object_width information, and the object_height information for each button displayed in an image from the interactive graphics decoder 77, for example, in a state where an IG image (an image displayed on a screen based on IG stream data) such as a menu image is displayed on the screen.

In addition, the controller 53 generates display region information indicating a display region of each button displayed in the screen from the obtained information.

The touch determination of a button is performed by determining whether or not coordinates (coordinates indicating a touched position) indicated by the operation input information from the touch panel 92a are in a range of the display region indicated by the display region information generated in this way.

### 4. Information Processing Method according to Embodiment

Here, as understood from the description hitherto, the BD-ROM standard (particularly, the parts related to the IG) is designed on the premise of using the user interface for performing an operation using the direction keys or the determination key of the remote controller or the like. In other words, inherently, the BD-ROM standard does not handle an interface such as the touch panel 92a where any position on the screen can be directly indicated.

On the other hand, although the BD-ROM standard allows, for example, the presence of the hidden button described with reference to FIG. 25 or 26, even the hidden button satisfies the BD-ROM standard, and thus a direct operation of the hidden button is excluded.

As described above, since the hidden button shows an inherent function when selected through the direction key operation, in a case where the hidden button is operated at an unexpected timing due to an operation using the touch panel 92a, there is concern that operation errors may occur.

Therefore, in the embodiment, if a user interface such as the touch panel 92a where buttons on a screen can be directly operated is employed, a prevention method described below is used to prevent operation errors from occurring.

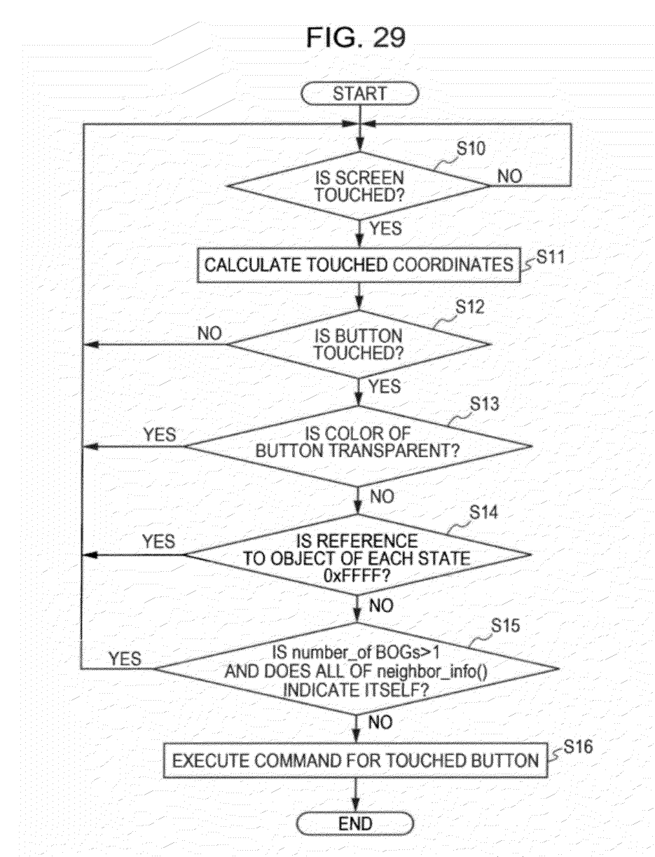

FIG. 29 is a flowchart illustrating an information processing method according to an embodiment.

The flowchart shown in FIG. 29 is executed by the controller 53 shown in FIG. 27, for example, according to a program stored in a memory such as the above-described ROM.

First, in step S10, touch on the screen is awaited. That is to say, reception of operation input information from the touch panel 92a is awaited.

If the operation input information is received from the touch panel 92a, and an affirmative result that the screen is touched is obtained, the flow goes to step S11, where the touched coordinates are calculated.

Next, in step S12, it is determined whether or not a button is touched. That is to say, the above-described touch determination is performed.

Specifically, it is determined whether or not the coordinates calculated in step S11 are in a range indicated by the display region information of each button generated based on the information of the button_horizontal_position, the button_vertical_position, the object_width, and object_height for each button in the screen, obtained from the interactive graphics decoder 77 in advance.

In step S12, if a negative result that the coordinates calculated in step S11 is not in any range indicated by the display region information of each button and a button is not touched is obtained, the flow returns to step S10 as shown in the figure, where touch on the screen is awaited again.

On the other hand, if an affirmative result that the coordinates calculated in step S11 are in a range indicated by the display region information of each button and a button is touched is obtained, the flow goes to step S13.

It is possible to prevent operation errors caused by a direct operation of the hidden button from occurring through processes in steps S13 to S15 including step S13.

First, in step S13, it is determined whether or not the color of the button is transparent. That is to say, it is determined whether or not the color of the button touched in step S12 is transparent.

As described above, color information (information for opacity) for a button is stored in the PDS transmitted by the IG stream. The controller 53 obtains opacity information for the touched button via the interactive graphics decoder 77, and determines whether or not the color of the button is transparent based on the opacity information. Specifically, it is determined whether or not the color of the touched button is transparent based on, for example, a result of comparing a value of the opacity indicated by the opacity information with a threshold value set in advance.

If an affirmative result that the color of the button is transparent is obtained in step S13, the flow returns to step S10 as shown in the figure. That is to say, thereby, in order to handle a case where the color of the touched button is transparent, in other words, a case where the touched button is a hidden button which is not expected to be directly operated, a command corresponding to the button may not be executed.

On the other hand, if a negative result that the color of the button is not transparent in step S13, the flow goes to step S14.

In step S14, it is determined whether or not a reference to an object of each state is 0xFFFF. That is to say, it is determined whether or not a reference to an object by each object_id_ref in the normal_state_info( ) the selected_state_info( ), and the activated_state_info( ) shown in FIG. 19 is 0xFFFF (that is, whether or not to store valid information as image reference information).

If an affirmative result that a reference to an object of each object_id_ref is 0xFFFF is obtained, the flow returns to step S10. Thereby, a command corresponding to the button may not be executed in order to handle a case where the image reference information corresponding to the touched button is not valid (that is, in a state where an image as the button is not displayed), and the touched button is a button which is not expected to be directly operated.

If a negative result that a reference to an object of each object_id_ref is not 0xFFFF is obtained in step S14, the flow goes to step S15.

In step S15, it is determined whether or not all of neighbor_info( ) indicate itself (self button) at number_of_BOGs>1. Here, as described above, number_of_BOGs indicates the number of buttons displayed in a page. In addition, neighbor_info( ) is information indicating which button is transitioned to a selection state when the direction keys are operated in a selection state of the button.

If an affirmative result that all of neighbor_info( ) indicates itself (self button) at number_of_BOGs>1 in step S15, the flow returns to step S10. Thereby, a command corresponding to the button may not be executed in order to handle a case where the touched button is a button which is not expected to be directly operated.

In addition, if a negative result that none of neighbor_info( ) indicate itself (self button) at number_of_BOGs>1 is obtained in step S15, the flow goes to step S16 where a command corresponding to the touched button is executed.

In this way, in a case where a negative result is obtained in all the determination processes in steps S13 to S15, in other words, in a case where the touched button is not a button which is not expected to be directly operated, a command corresponding to the touched button is executed.

The controller 53 performs the process in step S16 and finishes a series of processes shown in the figure.

According to the information processing method of the embodiment as described above, in a case where an operation unit such as the touch panel 92a where a display region of a button on the screen can be directly indicated is provided, it is possible to effectively prevent occurrence of operation errors caused by a direct operation of a button as a hidden button which is not expected to be directly operated (directly indicated) by a user.

### 5. Modified Example

As such, although the embodiment of the present disclosure has been described, the present disclosure is not limited to the detailed example described hitherto.

For example, the determination as to whether or not a button is expected to be directly operated is performed based on the three conditions (S13 to S15) in FIG. 29, but they are only an example and are not limited to the conditions.

As an example, in the condition in step S13, the color of a button is not necessarily completely transparent. That is to say, if the opacity is regarded as being transparent, it may be regarded as being transparent.

In addition, in relation to step S15, instead of determining whether or not all the neighbor_info( ) of the button indicate the self button, it may be determined whether or not a touched button is indicated based on any neighbor_info( ) thereof by referring to the neighbor_info( ) of each button in a page.

Further, in the description hitherto, a plurality of conditions for determining whether or not a button is expected to be directly operated are related, and if one of them is satisfied, a determination result that the button is not expected to be directly operated is obtained. However, when two or more conditions of a plurality of conditions are satisfied, a determination result that a button is not expected to be directly operated may be obtained.

In addition, although, in the description hitherto, an example of using a touch panel as an operation unit where a button on a screen can be directly indicated has been described, the present disclosure is appropriately applicable to a case of using a pointing device such as a mouse.

In this case, coordinate information indicating a position which is clicked on a screen by the mouse (a position on the screen indicated by a cursor, which is moved by a mouse operation, when the click is performed) may be treated as information corresponding to operation input information output by the touch panel 92a described according to the embodiment.

Further, although, in the description hitherto, a button on the screen is determined as being indicated via the operation unit, and then it is determined whether or not the indicated button is expected to be directly operated, instead thereof, it may be determined in advance whether or not a button is expected to be directly operated for each button displayed on a page.

The present disclosure contains subject matter related to that disclosed in Japanese Priority Patent Application JP 2010-223705 filed in the Japan Patent Office on Oct. 1, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
an information processing unit that determines whether or not a button indicated by an operation is a button which is not expected to be directly indicated, based on button related information which is formed by correlating information related to each button displayed on a screen with each button and is recorded on a necessary recording medium, and operation input information from an operation unit where an operation for directly indicating a display region of each button can be performed, in relation to the button displayed in a predetermined display region on the screen based on the button related information recorded on the recording medium, and does not execute a command correlated with the button related information of the indicated button if the indicated button is the button which is not expected to be directly indicated as a result of the determination.

2. The information processing device according to claim 1, wherein the information processing unit determines whether or not the indicated button is the button which is not expected to be directly indicated based on button color information correlated with the indicated button as the button related information.

3. The information processing device according to claim 1, wherein the button related information includes image reference information for indicating an image to be displayed for each state of a non-selection state, a selection state, and an execution state of a button, and
wherein the information processing unit determines whether or not the indicated button is the button which is not expected to be directly indicated based on a result of determination as to whether or not valid information is stored as the image reference information for each state of the non-selection state, the selection state, and the execution state regarding the indicated button.

4. The information processing device according to claim 1, wherein the button related information includes neighboring button information which is information for indicating a button which enters a selection state next time in response to a direction key operation performed when a button is in a selection state, and
wherein the information processing unit determines whether or not the indicated button is the button which is not expected to be directly indicated based on a result of determination as to whether or not the number of buttons displayed on the screen is two or more, and all pieces of the neighboring button information for the indicated button indicate the indicated button itself.

5. The information processing device according to claim 1, wherein the button related information includes coordinate information, width information, and height information for specifying a display region of a button on the screen for each button,
wherein the operation unit supplies coordinate information for specifying a part where an indication operation is performed in the screen to the information processing unit as the operation input information, and
wherein the information processing unit determines whether or not an operation indicating a button displayed in the screen is performed based on the coordinate information supplied from the operation unit, the coordinate information, the width information, and the height information in the button related information.

6. The information processing device according to claim 1, wherein the operation unit is a touch panel.

7. The information processing device according to claim 1, wherein the recording medium is a blu-ray disc.

8. An information processing method comprising:
determining whether or not a button indicated by an operation is a button which is not expected to be directly indicated, based on button related information which is formed by correlating information related to each button displayed on a screen with each button and is recorded on a necessary recording medium, and operation input information from an operation unit where an operation for directly indicating a display region of each button can be performed, in relation to the button displayed in a predetermined display region on the screen based on the button related information recorded on the recording medium; and
not executing a command correlated with the button related information of the indicated button if the indicated button is the button which is not expected to be directly indicated as a result of the determination.
